(19) United States
(12) Patent Application Publication
(10) Pub. No.: US 2009/0319344 A1
(43) Pub. Date: Dec. 24, 2009

(54) ASSESSMENT OF SALES FORCE PERSONNEL FOR IMPROVEMENT OF SALES PERFORMANCE

(76) Inventors: Samuel R. Tepper, Chicago, IL (US); Richard J. Bakosh, Oswego, IL (US); Richard Hagberg, Langley, WA (US)

Correspondence Address: Vedder Price PC, 222 NORTH LASALLE STREET, CHICAGO, IL, 60601, US

(21) Appl. No.: 12/141,247

(22) Filed: Jun. 18, 2008

(51) Int. Cl. G06F 11/34; G06F 9/44

(52) U.S. Cl. 705/11; 705/7

(57) ABSTRACT

Personality, behavior and competency assessment data is obtained for a sales person (or group of sales persons), particularly via a computer-implemented interface. The resulting overall individual (or aggregated) assessment data is then compared with high sales performer benchmark data to identify performance improvement opportunities that, in turn, are used to identify at least one specific action for the sales person (or group of sales persons). Such techniques may be use with sales management personnel as well. Reports based on the assessment results and comparisons thereof with high sales performer benchmark data may be created and provided to the individuals being assessed or persons associated with the individual sales persons. The personality, behavior and competency assessment data may also be used to identify predictive characteristics of high sales performers that may be subsequently used to predict other characteristics of individuals or groups.

### FIELD OF THE INVENTION

The instant disclosure relates generally to techniques for assessing sales force personnel and, in particular, to techniques for improving individual and organizational sales performance based on such assessments.

### BACKGROUND OF THE INVENTION

Given that the major percentage of a corporate organization's revenue comes from the act of selling, sales success is tantamount to overall success. Sales force effectiveness is therefore a prime concern for all companies that do business in the global arena. Selling is an increasingly complex task, however, as market forces, including economic fluctuations, increased competition, increased commoditization of products and services, and continued customer globalization are creating more and more demands on sales representatives and managers. In order to stay competitive in the marketplace, an organization's sales performance must be continually optimized and improved.

FIG. 1 illustrates how overall sales force performance may be improved. A first curve 110 illustrates the current performance distribution for an organization's sales force. As is often the case, such performance curves 110 take the form of a Gaussian distribution, i.e., the so-called bell curve, such that the bulk of sales persons fall within a middle or core region 112, with both low and high performers occupying the respective tails 114, 116. In order to improve overall sales performance, it is desirable to not only improve the performance of individual sales persons, but to shift the entire performance curve up, as illustrated by the second curve 120. Additionally, it is desirable to shift the relative proportions of the low, core and high regions. For example, assume the core region 112 of the first curve 110 encompasses 70% of an organization's sales force, whereas the low performer region 114 and high performer region 116 respectively encompass 10% and 20% of the sales force. As illustrated by the second curve 120, overall sales performance may be improved not only by shifting the curve up, e.g., 10% better performance by average performers (the peaks of each curve), but by also moving individual sales people from lower regions to higher regions of the curve 120. For example, the second curve illustrates that the low performer region 124 now comprises 5% of the sales force, whereas the core and high performer regions now encompass 65% and 30%, respectively, of the sales force.

Achieving such performance curve shifts using existing techniques is a difficult task. While it is sometimes the case that certain experienced individuals are capable of intrinsically recognizing high performer sales ability, such skills are not scalable as it is unreasonable (and virtually impossible) for one person, or small group with the “right” instincts, to interview each new representative or manager and populate even a modestly-sized sales force with the most successful individuals. Moreover, a sales force improvement requires more than good hiring practices, including the ability to identify and addresses negative influences such as high rates of attrition, non-optimal training, steep new-hire learning curves and ineffective use of customer relationship management (CRM) systems, to name but a few.

Thus, it would be advantageous to provide techniques that address the various obstacles to implementing continuous and overall sales force improvement.

### SUMMARY OF THE INVENTION

The instant disclosure describes systematic, repeatable and scalable techniques for assessing sales force personnel in furtherance of individual sales person and overall sales force performance improvement. To this end, personality assessment data, behavior assessment data and competency assessment data is obtained for a sales person, in one embodiment, via a computer-implemented interface. The assessment data may be obtained not only from the individual being assessed, but by those persons associated with the individual sales person. The resulting overall individual assessment data is then compared with high sales performer benchmark data to identify performance improvement opportunities that, in turn, are used to identify at least one specific action for the sales person. By repeating this process across substantially all of a sales organization's personnel, aggregated assessment data may be obtained to identify individual specific actions and/or specific actions applicable to the most, if not all, of the sales organization. Such techniques may be employed not only for sales persons, but sales management personnel as well. Reports based on the assessment results and comparisons thereof with high sales performer benchmark data may be created and provided to the individuals being assessed or persons associated with the individual sales persons. After implementation of some or all of the specific actions, subsequent assessment data may be obtained to determine a level of change experienced by the individual or aggregated sales personnel. Because personality, behavior and competency assessment data is obtained, a more robust and comprehensive understanding is provided for each individual sales person and the overall sales organization as a whole. In one embodiment, the above-described techniques may be implemented using known software programming techniques, i.e., suitable instructions executed by one or more processing devices.

In another embodiment, the personality, behavior and competency assessment data across a plurality of sales persons may be used to identify predictive characteristics of high sales performers. Thereafter, the personality, behavior and competency assessment data for an individual sales person may be obtained. Based on the individual personality assessment data and at least a portion of the predictive characteristics, either or both of behavior characteristics and competency characteristics may be predicted. In a similar vein, behavior assessment data and another portion of the predictive characteristics may be used to predict competency characteristics or vice versa. Such predictive qualities may be beneficially used in a variety of situations including, but not limited to, hiring, firing, development and/or promotion decisions within a sales organization. Once again, such techniques may be implemented using known software programming techniques.

Using the techniques described herein, it is possible to assess a sales organization to understand the differences between low, core, and high performers at both representative and all manager (including upper management) levels, while also showing how the three assessed categories (personality, competencies, and behaviors) interact in order to create a predictive model that will beneficially shift the performance curve (as well as the ratios within the curve) within the organization.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a graph illustrating a desirable shift in sales performance by an organization's sales force;

FIG. 2 is a schematic block diagram illustrating a system for implementing various embodiments described herein;

FIG. 3 is a schematic block diagram illustrating, in greater detail, a system for implementing various embodiments described herein;

FIG. 4 is a flowchart illustrating processing according to an embodiment described herein;

FIG. 5 is a flowchart illustrating processing according to another embodiment described herein; and

FIGS. 6-14 are examples of a graphical user interface in accordance with various embodiments described herein.

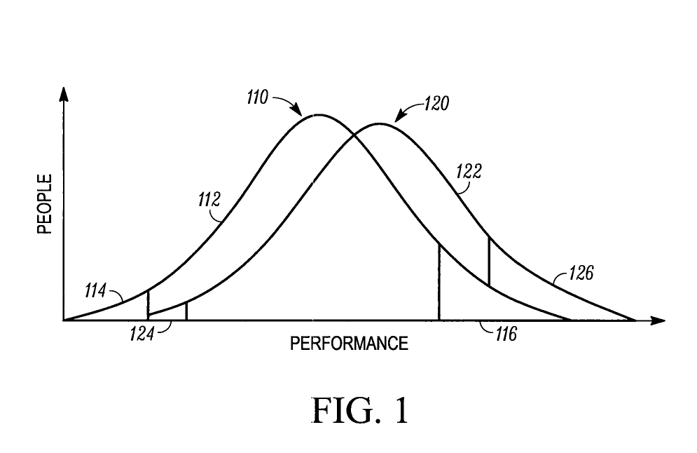

### DETAILED DESCRIPTION OF THE PRESENT EMBODIMENTS

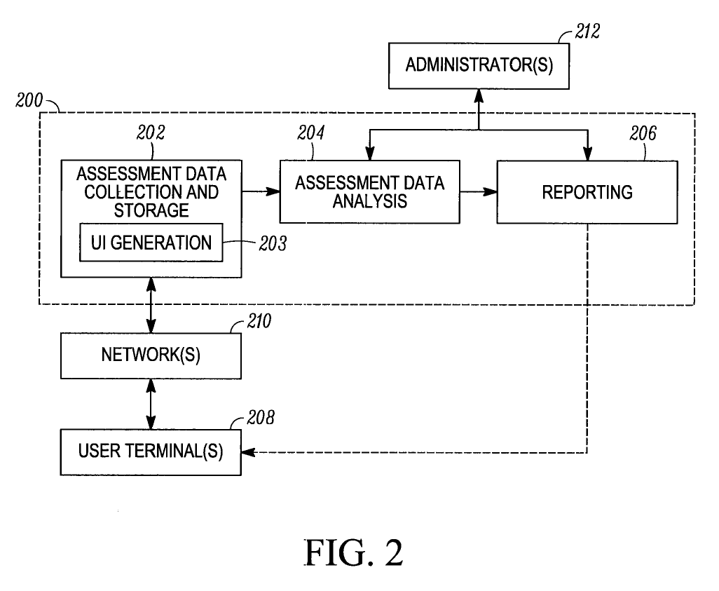

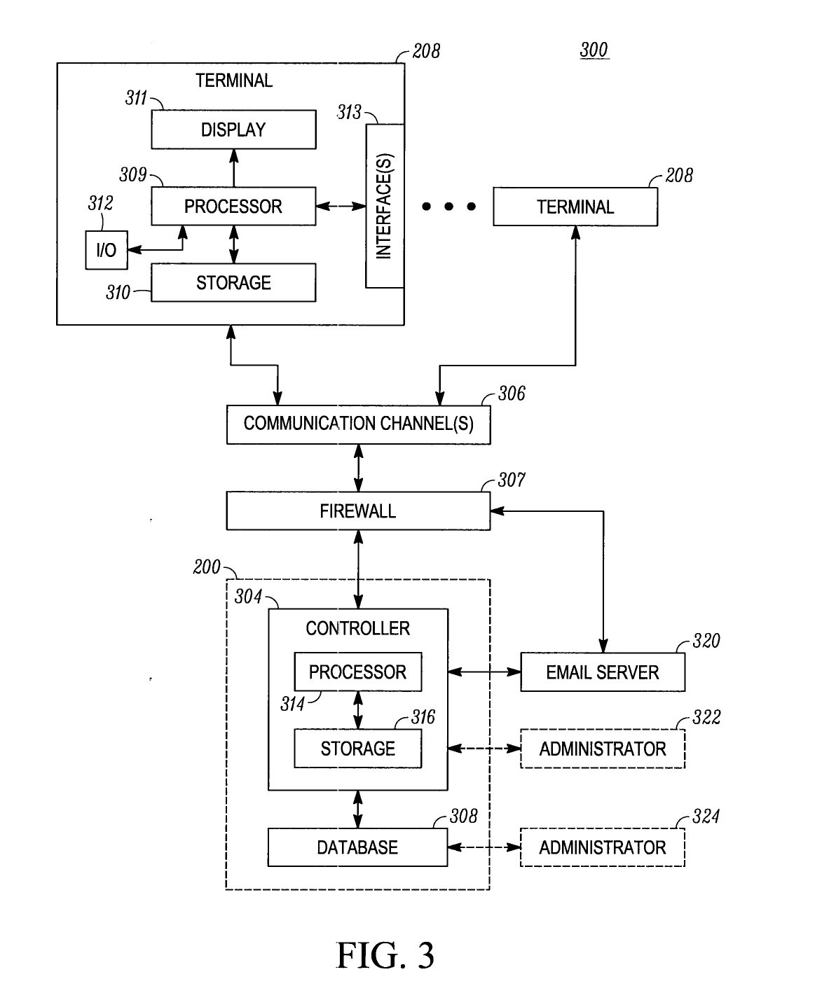

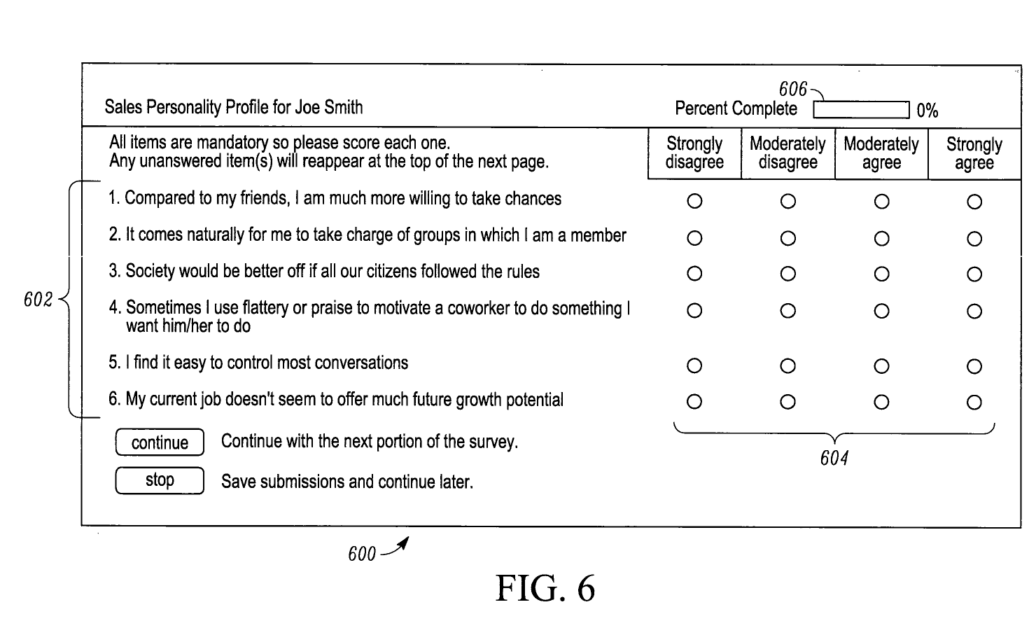

Greater understanding of the various embodiments described herein may be obtained through further reference to FIGS. 2-14 and the accompanying description set forth below. Referring now to FIG. 2, an apparatus 200 is illustrated comprising an assessment data collection and storage component 202 in communication with an assessment data analysis component 204 that, in turn, is in communication with a reporting component 206. As described in greater detail below, particularly with reference to FIG. 3, each of the components 202-206 may comprise one or more suitable programmed processing devices, such as server computers. Communicating with one or more user terminals 208 via a suitable communication network or networks 210, the assessment data and collection storage component 202, as described in greater detail below, operates to provide a suitable user interface, via the user interface generation component 203, to the one or more terminals 208 with which it communicates. The user interface generation component 203, using known programming techniques, may provide one or more display screens that can be rendered on one of more of the user terminals 208 as a means for obtaining assessment data from a user of a corresponding terminal 208. The display screens may take the form of a survey questionnaire as illustrated in FIGS. 6-10. Note that the particular content of the display screens may be customized as desired.

As described in greater detail below, the assessment data obtained by the collection and storage component 202 generally concerns three categories applicable to sales personnel, personality assessment data, behavior assessment data and competency assessment data. The personality assessment data provides objective, in-depth data chosen to elicit key aspects of personality that influence high performance sales. Similarly, the competency assessment data provides insight into an individual sales representative's and/or manager's competency strengths and areas for development. Finally, the behavior assessment data relates to the actual day-to-day sales activities (as well as broader, less frequent activities not usually undertaken each week or even each month) that sales representatives and sales managers engage in to complete their tasks, functions, and roles. In addition to collecting and storing assessment data associated with individual sales representative and/or sales managers, the collection and storage component 202 may also operate to aggregate the assessment data such that aggregated assessment data for at least a portion of, if not substantially all of, a sales organization is available. This is possible due to the standardized nature of the data collection interface employed by the collection and storage component 202, as described below. Further still, the aggregated data may be provided according to specific organizational groupings, e.g., by specific sales function, region, product line, etc.

The assessment data analysis component 204 performs any of a number of well-known statistical analysis techniques on the assessment data provided by the collection and storage component 202. As shown, one or more administrators 212 can access the assessment data analysis component 204 in order to work with the assessment data. For example, in one embodiment, a first pass analysis is done by one or more subject matter experts (SMEs)/developers (i.e., administrators 212). In this embodiment, the SMEs 212 download the assessment data from the collection and storage component 202 into any of a number of commercially-available statistical software packages where the appropriate analysis is conducted. The statistical software may comprise any and all statistical routines necessary to slice and parse the data by required segments (e.g. individual vs. aggregate, sales representative vs. sales manager, across geographical units, etc.), including but not limited to, between samples t-tests, within samples t-tests, simple chi-square distribution analysis, etc. The assessment data analysis component 204, via the statistical software, may also be used for predictive modeling using a variety of techniques including regression modeling, analysis of variance (ANOVA), analysis of covariance (ANCOVA), etc. to understand how each of the variables helps to predict one another and high performance sales. Further still, the assessment data analysis component 204 may also comprise the software necessary to perform so-called “longitudinal analysis” when monitoring an individual or organization(s) over time. When the SMEs 212 have properly configured the desired analysis routines in the assessment data analysis component 204, they are thereafter available to be instantiated as desired on the assessment data or any portion thereof.

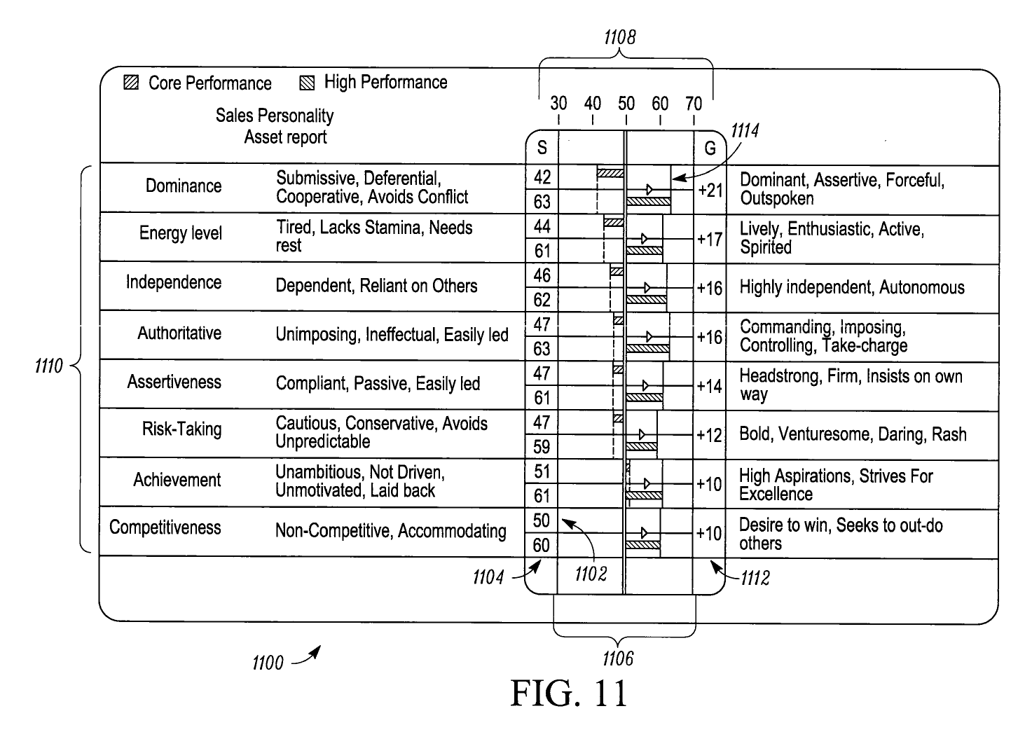

The reporting component 206 operates upon the results of the assessment data analysis component 204 to provide the results in useful formats for subsequent users. Examples of such reports are illustrated in and further described with reference to FIGS. 11-14. Those of skill in the art will appreciate that the particular formats illustrated in FIGS. 11-14 are merely illustrative of the large number of presentation formats that may be used for this purpose. As shown in FIGS. 11-14, the statistical analysis results may be presented in graphical formats that are generated using suitable software programs (including, but not limited to, the analysis software described above) known to those of skill in the art. By way of non-limiting illustrative example, such reports may include individual reports for the personality, competency and behavior assessments, or similar aggregated assessment data across any desired personnel grouping. Further still, the reports generated by the reporting component 206 may be provided to any of a number of relevant parties as schematically illustrated by the dotted line between the reporting component 206 and the one or more user terminals 208, although it is understood that provision of such reports need not be restricted to the specific user terminals 208 used in the assessment date collection process. Such parties may include, but are not limited to, the individual sales personnel (representatives and/or manager) being assessed, anyone directly associated with such personnel (e.g., supervisors, subordinates, peers, customers, vendors, etc.), training personnel or executives responsible for the sales organization. For example, in one embodiment, a manager having subordinates that report to the manager and for whom the manager has responsibility may be provided with secured access (e.g., password protected) to the reporting component 206. An interface screen may then be presented to the manager where the manager can generate reports regarding the manager's subordinates (the entire group, subgroups or individuals thereof) and/or compare them against the overall organization or other subgroups, including high performers, within the organization. Using this information, the manager can better coach his/her subordinates to facilitate the desired improvement.

Referring now to FIG. 3, a system 300 comprising more detailed illustrations of the various components of FIG. 2 is shown. Beginning with the apparatus 200, a controller 304 in communication with a database 308 is provided. In an embodiment, the controller 304 comprises one or more server computers implementing web server software, such as Windows Server 2003 operating system using .Net Framework 2.0 software and Internet Information Services (IIS) 6.0 Web Server software. As known in the art, the controller 304 comprises one or more processors 314 in communication with at least one storage component 316 that stores instructions used by the processor(s) to implement the various functions described herein relative to the apparatus 200 of FIG. 2. In a similar vein, the database 308 may comprise one or more server computers implementing suitable database software, such as Windows Server 2004 operating system using Microsoft SQL Server 2005 software. While the techniques described herein may be implemented using suitably programmed computers, as illustrated in FIG. 3, those having ordinary skill in the art will appreciate that any suitable combination of software and hardware components may be used for this purpose. For example, dedicated hardware components, such as application specific integrated circuits (ASICs), programmable logic arrays, state machines, etc. may be equally employed as a matter of design choice.

The controller 304 is accessed, via a suitable firewall 307 and communication channel(s) 306 by the one or more user terminals 208, as shown. The communication channel(s) may comprise any combination of public or private networks including, but not limited to, private networks such as local area networks (LANs), public networks such as the Internet or World Wide Web or wireless networks. Each terminal 208 may comprise a suitable processing platform (such as a personal computer, handheld computer, personal digital assistant, mobile phone, etc.) capable of communicating with the controller 304 via the communication channel(s) 306. As such, each terminal 208 includes at least one processor 309 in communication with one or more storage components 310 as in the case of the controller 304. As further shown, the processor(s) 309 are also in communication with a display 311, other user input/output devices 312 and interface components 313. The display 311 may comprise any conventional display screen or the like, depending on the particular nature of the terminal 208. The other user input/output devices allow a user to interact with the terminal 208 and may include, for example, a keyboard, mouse, touch screen, stylus, microphone, speaker, indicator lights, etc. The interfaces 313 may comprise any necessary software/firmware/hardware necessary to terminate any communication protocols supported by the terminal 208 such as, but not limited to, wired network protocols, wireless protocols, etc.

In one embodiment, the controller 304 and database 308, using known techniques, exist within a highly protected computing environment and communicate with each other using security protocols that are transparent to outside entities. Nevertheless, secured communication links between the controller 304 and/or database 308 may be provided (via computer-implemented terminals not shown) for use by one or more administrators 322, 324. For example, a first administrator 322 with relatively limited access may be allowed to access the controller 304 (web server) to handle project management duties such as ensuring input of personnel data, causing any required email communications to be undertaken, requesting specific analyses and reports, etc. Further still, a SME 324 may be granted access to the database 308 (in addition to the controller 304) for the purpose, for example, of statistical programming, creating and editing the reports, maintaining and updated business rules and functions, etc.

Finally, an email server 320, as known in the art, is provided to allow the controller 304 to communicate with the various terminals 208 using email. For example, this capability may be used to send notification emails to various sales force personnel (or those associated with such personnel) requesting that they participate in the assessment process and providing them instructions concerning how to access the controller 304 for this purpose.

In one embodiment, use of the system 300 begins when an administrator 322 receives data from the client concerning desired performance indicators, identification of respondents, roles, manager/supervisor and other reporting relationships, contact information, geographical locations, division(s), etc. The administrator 322 thereafter securely uploads the data (through either a web link or on-site) to the controller 304. The data is entered into the controller 304 where it creates scripts and unique codes for each respondent/assessment. The controller 304 thereafter sends instructions to the database 308 to populate the required email messages (email messages for all respondents that include their unique codes and web links are stored in the database 308). These messages, once populated with the correct information, are sent back to the controller 304 that, in turn, sends out the messages to the respondents via the email server 320, through the firewall 307, where it is subsequently provided to the intended respondent. Each respondent then activates the web link and enters his/her unique code provided via the email for each assessment (i.e., the personality, competency, and behavior assessments). Activation of the link establishes communications between the respondent's terminal 208 and the controller 304. The assessment scripts are executed by the controller 304 causing the appropriate user interface displays to be presented on the respondent's terminal 208 (e.g., via the display 311). In response, the respondent can reply to the questions presented (using, e.g., the user input devices 312) such that the resulting assessment data is provided to the database 308. For any given participant being assessed, the assessment data may include the identifications of others who will/should be rating the participant (e.g., peers, managers, subordinates, customers, etc.). Based on this information, emails similar to those described above will be sent to the individuals identified in this manner.

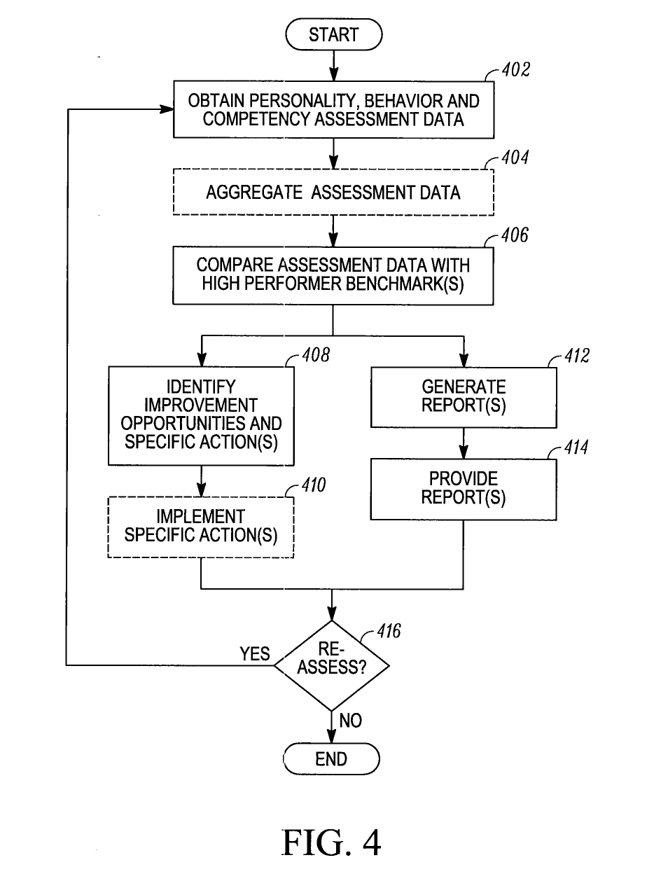

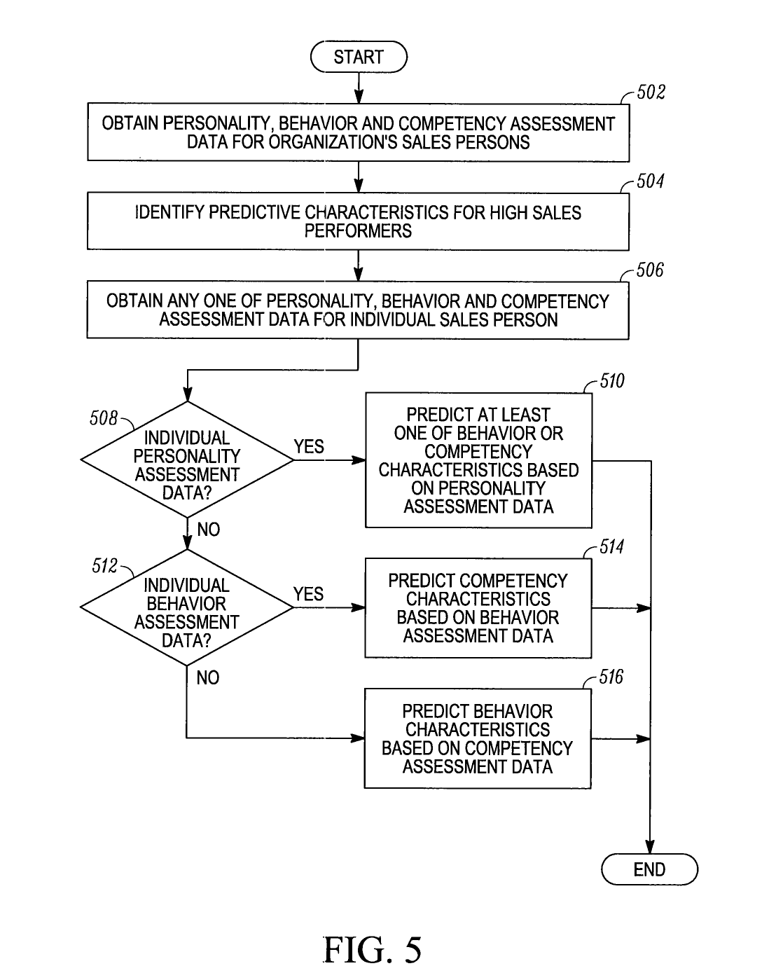

FIGS. 4 and 5 illustrate processing performed by the apparatus 200, preferably in the form of stored instructions being executed by one or more suitable processors, according to alternative embodiments. Once again, those of ordinary skill in the art will appreciate that other implementation techniques may be equally employed for this purpose. Referring now to FIG. 4, processing begins at block 402 where personality, behavior and competency assessment data is obtained. As noted above, such assessment data is typically obtained directly from the person being assessed, i.e., an individual sales representative or sales manager, but may also include additional persons associated with the individual. In the case where multiple parties contribute to the assessment of an individual, the multiple response can be combined in any desirable fashion (e.g., straight averages, weighted averages, etc.) to provide a single set of individual assessment data. In one embodiment, such additional reviewers are allowed to provide assessment data only for the competency assessment data. Regardless of the type of assessment data gathered in this manner, the resulting combined data may be based on a variety of factors, including how well the person rating knows the participant, etc.

Regarding the personality assessment, in an embodiment, the collected assessment data comprises answers to questions concerning up to 46 different aspects of personality that are correlated with high performance sales at the representative and manager level. Table 1 below summarizes these different aspects. While specific aspects are listed in Table 1, it is understood that other personality-related aspects concerning sales performance could be equally employed as a matter of design choice, or that the listed aspect could be combined in some manner with each other or with other aspects not shown. Furthermore, those specific aspects questioned are often industry- or organization-dependent, such that only a subset of the aspects listed in Table 1 are used.

TABLE 1

| Personality Aspect | Summary |
|---|---|
| Achievement | A measure of how ambitious the person is. |
| Adaptability | A measure of how flexible or adaptable the person is to various |
| | external stimuli. |
| Aggression | A measure of how aggressive and forceful the person is. |
| Agreeableness | A measure of how good-natured or friendly a person is. |
| Analytical | A measure of how much the person thinks or lacks depth. |
| Anxiety | A measure of whether or not the person is highly anxious or |
| | frequently worried. |
| Assertiveness | A measure of how headstrong the person is. |
| Attention to Detail | A measure of how meticulous a person is. |
| Authoritative | A measure of how commanding and controlling the person is. |
| Competitiveness | A measure of how much the person desires to win. |
| Complexity | A measure of how predictable the person is. |
| Compensation | A measure of how satisfied on is with one's pay, benefits, and perks. |
| Satisfaction | |
| Conformity | A measure of how conforming the person is to group behavior. |
| Dominance | A measure of how dominant and assertive a person is. |
| Empathy | A measure of whether or not one identifies with others. |
| Endurance | A measure of how persistent and determined a person is. |
| Energy Level | A measure of how enthusiastic and active the person is. |
| Impulsiveness | A measure of how reckless or spontaneous a person is. |
| Independence | A measure of how independent and autonomous the person is. |
| Integrity | A measure of how honest and ethical a person is. |
| Intuition | A measure of how insightful the person is. |
| Job Satisfaction | A measure of how happy one is with one's work conditions. |
| Locus of Control | A measure of how much a person believes he/she has a hand in his her |
| | own fate. |
| Nurturance | A measure whether a person cares about the bottom line or about |
| | people. |
| Openness | A measure of how much one shares one's personal thoughts or |
| | feelings with others |
| Openness to Experience | A measure of how much the person is open to new experiences. |
| Optimism | A measure of how positive one's outlook on life is. |
| Order | A measure of how systematic and orderly a person is. |
| Patience | A measure of how composed or relaxed the person is. |
| Polychronicity | A measure of how well a person can handle multiple tasks |
| Responsibility | A measure of how dedicated on committed a person is to one's work |
| | and/or actions. |
| Risk-Taking | A measure of how cautious the person is. |
| Self-Confidence | A measure of how confident one is as a person |
| Self-Monitoring | A measure of how much a person changes in a social situation. |
| Self-Reflection | A measure of how self-reflective or introspective the person is. |
| Self-Starter | A measure of how independent a worker the person is. |
| Social Adroitness | A measure of how socially shrewd a person is. |
| Social Confidence | A measure of how confident one is with other people, e.g. not easily |
| | embarrassed |
| Sociability | A measure of how much a person likes social groups. |
| Social Recognition | A measure of whether or not the person seeks out and/or needs |
| | recognition and awards. |
| Sympathy/Compassion | A measure of how kindhearted a person is. |
| Tolerance for | A measure of how tolerant one is of life's uncertainties. |
| Ambiguity | |
| Toughness | A measure of how cool and calm the person is in a crisis. |
| Traditional Values | A measure of how conventional or traditional the person is. |
| Trust | A measure of how much the person trusts or is suspicious of others. |
| Warmth | A measure of how affectionate the person is. |

In a current implementation, approximately 370 questions that gauge the 46 different personality aspects are provided. The questions are selected to provide an objective analysis of personality traits (stable, innate personality attributes) and states (those personality components that are affected by situation and context) that inform on potential challenges to high performance sales effectiveness. When combined with the competency and behavior assessments, the personality assessment data shows clear influences that reduce error of situational contexts that may have a bearing on results. The personality-related questions are selected to include both faking and social desirability scales to ensure that respondents do not lie or engage in impression management to skew results. The assessment is not timed, so the respondent can work on it in any environment that allows him/her to concentrate. It is strongly recommended that the respondent complete the entire assessment as quickly as possible, however. Periodic breaks can be taken at any point throughout; however, it is recommended that break periods be a maximum of to 5 to 10 minutes. In the current implementation, the entire assessment should take approximately 45-60 minutes to complete, depending on the respondent's speed and the length of breaks.

FIG. 6 illustrates an example of a user interface display 600 that may be used when collecting the personality assessment data. As shown, the various questions 602 may be phrased to ask the respondent about his/her behaviors, characteristics, and how they see themselves while other items ask about how they see other people. In one embodiment, the questions presented (regardless whether they are applicable to personality, behavior or competency) are vetted to be as culturally desensitized as possible, i.e. taken out slang, jargon, etc., thereby broadening applicability to the widest possible audience and allowing people from different cultures to understand the meaning of each question, regardless of the language in which it's presented. In this manner, the answers to the personality assessment questions contribute to an understanding of the respondent's personal qualities as they relate to various dimensions of sales, leadership and elements of corporate culture/work environment. As shown, a response scale 604 may be employed to measure the respondent's answers. In the illustrated example, a 4-point scale, from “Strongly Disagree” to “Strongly Agree”, is provided for each question. As known in the art, other response scales and/or different question formats (e.g., multiple choice, true-false, etc.) may be equally employed for this purpose. Furthermore, in the illustrated example, all questions are deemed mandatory and must be answered before the respondent can continue with the survey. However, this is not a requirement and lesser portions of a given set of question could be mandatory, with the balance being deemed optional, as a matter of design choice. To assist the respondent, a percentage bar 606 is provided that allows the respondent to track his/her progress in completing the personality assessment.

Regarding the competency assessment, in an embodiment, the collected assessment data comprises answers to questions concerning up to 44 core sales competencies, plus 29 additional unique sales representative competencies and 73 unique sales manager competencies. Once again, while specific competencies are set forth below, it is understood that other competencies concerning sales performance could be equally employed as a matter of design choice, that the listed competencies could be combined in some manner with each other or with others not shown and that selected, industry-dependent subsets of the listed competencies may be employed. In particular, the competencies listed below represent the inclusive list of required competencies, of which, through analysis, a subset will emerge that is unique to that client, and statistically differentiated. Table 2 summarizes the core competencies that are applicable to both sales representatives and sales managers.

TABLE 2

| Core Competency | Summary |
|---|---|
| Adaptability | Adapts to rapidly changing situations and priorities, tolerates ambiguity, |
| | and develops new behaviors to achieve objectives and overcome |
| | obstacles. |
| Administration | Completes all administrative tasks that are necessary for effective |
| | management of territory as well as sales and/or organizational goals |
| Analytical Thinking | Uses an objective methodical approach to analyze complex problems and |
| | identify causes to arrive at an appropriate solution. |
| Attention to Detail | Is thorough and takes into account the necessary details to achieve |
| | success in one's work. |
| Builds Rapport and | Has the ability to develop relationships and become a trusted advisor. |
| Relationships | |
| Business Acumen | Demonstrates an understanding of business functions, processes, and |
| | indicators. |
| Coaching | Helps team members improve selling effectiveness by providing regular |
| | feedback including both positive reinforcement and constructive |
| | criticism. |
| Communication | Applies effective verbal, nonverbal, and written communication |
| | techniques to create shared understanding and clarity. |
| Conflict Resolution | Facilitates conflict resolution by surfacing and clarifying areas of |
| | disagreement and by creating an environment where resolution is |
| | possible. |
| Creativity | Develops innovative and/or creative ideas to overcome challenges and |
| | solve problems. |
| Cultural Awareness | Demonstrates organizational cultural sensitivity, working effectively |
| | within one's own culture and client culture(s) to achieve business |
| | objectives. |
| Customer Focus | Has intimate knowledge of the customer organization, its industry, its |
| | customers and competition, and continually pursues updates to that |
| | knowledge base in order to better service the customer. |
| Data Gathering | Effectively uses appropriate resources and sources of information to |
| | gather data in support of achieving business objectives. |
| Decision Making | Applies a rational, objective, data-based decision making process to |
| | make sound decisions. |
| Decisiveness | Makes sound decisions without unnecessary delay, even in tough |
| | situations. |
| Dependability | Consistently gets the job done, meets deadlines, delivers on |
| | commitments, and is reliable. |
| Drive to Achieve | Is motivated to succeed, thrives on challenges, demonstrates |
| | perseverance, and drives towards personal and/or team objectives |
| | without settling for less than excellence. |
| Emotional Control | Maintains composure during times of stress, pressure, or disagreement; |
| | avoids unproductive confrontation and maintains a positive outlook in |
| | the face of adversity. |
| First Impression | Creates a positive first impression through social confidence, appropriate |
| | attire, sincerity, building credibility, and professional self presentation. |
| Forecasting | Accurately predicts the value and time to realization of future revenues |
| | and/or margin streams. |
| Holds Self | Demonstrates personal credibility, integrity, commitment to personal, |
| Accountable | team, and/or organizational goals, and accepts responsibility for one's |
| | actions undertaken to achieve one's goals and objectives. |
| Collaborative | Openly shares information with clients and colleagues, keeping them in |
| Information sharing | the loop about plans, activities, objectives, recent developments, and |
| | progress toward goals. |
| Interpersonal | Identifies and proactively resolves disagreements with others in an open |
| Conflict Resolution | and productive manner. |
| Leadership | Gives purpose and meaningful direction to a group, inspiring and |
| | motivating them to work toward the attainment of a desired goal. |
| Listening Skills | Actively attends to verbal and nonverbal messages and confirms that the |
| | entire message is accurately understood. |
| Managing Up | Realistically sets expectations of superiors, keeps them informed, and |
| | escalates issues when appropriate. |
| Negotiations | Creates win-win outcomes that enhance mutual business value over time. |
| Networking | Cultivates and leverages internal and external contacts to expand one's |
| | professional network. |
| Persuasion | Uses techniques and actions intended to convince the target to accept a |
| | desired outcome. |
| Planning and | Spends time most efficiently by planning, organizing, and implementing |
| Organizing | a systematic approach to business activities. |
| Political Savvy | Understands the customer's and the organization's formal and informal |
| | power structures; the motivations of key political stakeholders, and how |
| | buying decisions are actually made, in order to accomplish the sale. |
| Questioning | Utilizes open, closed, and leading questioning techniques to understand |
| | underlying beliefs, motivations, and causes for behaviors, needs, and |
| | desires. |
| Sees the Big Picture | Sees long-term trends, risks and opportunities and assesses their impact |
| | on both short and long-term decisions and actions. |
| Self Improvement | Continuously seeks to enhance personal behaviors, skills, capabilities, |
| | and deliverables (through a variety of means, including training and |
| | learning opportunities). |
| Self-Confidence | Demonstrates strong, realistic confidence in oneself and one's abilities. |
| Social Judgment | Understands and responds astutely and diplomatically in dealing with |
| Skills | others; understands the social dynamics of groups and organizations. |
| Storytelling | Uses purposeful stories, examples, or anecdotes to enhance |
| | understanding. |
| Strategic Thinking | Understands the implications of multiple decisions simultaneously and |
| | holistically rather than making individual decisions tactically. |
| Team Orchestration | Brings organizational groups together (e.g. finance, legal, IT, marketing, |
| | and others) to support all aspects of the sales process throughout the sales |
| | cycle. |
| Tactical Thinking | Is effective in identifying a set of short-term actions taken to fulfill |
| | longer-term strategic objectives. |
| Taking Initiative | Is an enthusiastic and determined self-starter who proactively identifies |
| | problems and opportunities and takes action without being asked. |
| Teamwork | Participates effectively as a team member; collaborates, listens, |
| | establishes trust with others, and demonstrates respect, while solving |
| | problems. |
| Technology Savvy | Applies technological tools appropriately and effectively to accomplish |
| | goals. |
| Time Management | Prioritizes one's tasks, activities, and goals to effectively manages one's |
| | time accordingly. |

Table 3 below summarizes the competencies that are specifically applicable to sales representatives.

TABLE 3

| Sales Representative | |
|---|---|
| Competency | Summary |
| Account Planning & | Strategizes, plans, and prioritizes sales activities for opportunities with |
| Management | new and existing customers. |
| Building Customer | Cultivates relationships with people who have and will share intimate |
| Advisors | knowledge about the customer's buying process and status in order to |
| | further the sales strategy. |
| Closing | Effectively utilizes closing techniques, such as creating a sense of |
| | urgency or overcoming objections, to execute the sale. |
| Coaching | Helps team members improve selling effectiveness by providing regular |
| | feedback including both positive reinforcement and constructive |
| | criticism. |
| Competitive | Gathers and utilizes knowledge and understanding of competitor |
| Intelligence | activities and behaviors throughout the sales cycle to improve sales win |
| | rates. |
| Contract Management | Effectively develops, presents, negotiates, and executes contracts and |
| | engages all appropriate resources to assist in that process. |
| Creating and | Creates a compelling persuasive document that represents and |
| Submitting Proposals | communicates the offering and its value in a manner that moves the |
| | sales process forward. |
| Cross and Up-Selling | Increases customer orders and sales by selling additional products |
| | and/or services offered by the organization. |
| Customer Service | Focuses firmly on the customer, responding to problems, inquiries, |
| | and/or complaints in a manner that consistently meets or exceeds |
| | expectations to further the relationship. |
| Develops the Solution | Creates a needs-based solution for customers that addresses all elements |
| | of the customer requirements and propels the sales person towards |
| | achieving their business objectives. |
| Forecasting | Accurately predicts the value and time to realization of future revenues |
| | and/or margin streams. |
| Influencing | Positively influences those individuals in a customer organization who |
| Gatekeepers | can provide access to a decision maker. |
| Identifying | Identifies those individuals in a customer organization that have the |
| Gatekeepers | potential to waylay a sale either directly or indirectly, in order to engage |
| | them, meet or address their underlying issues and needs so they either |
| | do not hinder the sale or actually change their role so as to help the sale |
| | close. |
| Information Seeking | Uncovers underlying customer needs, problems, desires, and/or |
| | challenges through research, questioning, probing, and analysis in order |
| | to provide a solution. |
| Information Sharing | Openly shares information with colleagues, keeping them in the loop |
| | about plans, activities, objectives, recent developments, and progress |
| | towards goals. |
| Knowledge - | Applies intimate knowledge of competitors' strategies and how to defeat |
| Competition | those strategies (addressing their products' and/or services features, |
| | benefits, strengths, weaknesses, advantages, and disadvantages). |
| Products/Services | Demonstrates depth and breadth of product and/or services knowledge |
| Knowledge | and skill in recommending specific solutions, estimating solution |
| | benefits, and establishing winning sales messages around the |
| | recommended solution. |
| Opportunity | Developing strategies and plans of action for sales success for each |
| Management and | evaluated and/or potential opportunity. |
| Planning | |
| Overcoming | Understands and overcomes the prospect's resistance and reluctance by |
| Objections | positively addressing objections. |
| Political Savvy | Understanding the customer's (and one's own) formal organizational |
| | structure, its informal power structure, what motivates and drives key |
| | political stakeholders, and how the buying decisions are actually made |
| | in order to accomplish the sale. |
| Post-Sale Follow-up | After the sale's close, continues the sales process to ensure the customer |
| | has received the benefit and value promised. |
| Proactively Guiding | Proactively moves the sales process forward, balancing customer needs |
| the Sales Process | and the needs of one's own organization. |
| Sales Call Planning | Conducts a pre-call planning session, assigning roles, responsibilities, |
| | and desired outcomes in preparation for a sales call in order to move the |
| | sales approach forward. |
| Sales Methodology | Understands and utilizes a sales methodology to more effectively move |
| | the sales process forward. |
| Sales Performance | Continually uses metrics to track progress toward sales goals. |
| Monitoring | |
| Sales Presentation | Delivers poised high impact presentations. |
| Team Orchestration | Plans, organizes, and aligns appropriate resources to meet customer |
| | product/service goals. |
| Territory | Aligns and prioritizes sales efforts within a defined territory to meet |
| Management and | assigned goals. |
| Planning | |
| Uses Channel | Works effectively with channel partners to develop and deliver an |
| Partners | effective solution for the customer. |

Table 4 below summarizes the competencies that are specifically applicable to sales managers.

TABLE 4

| Sales Manager | |
|---|---|
| Competency | Summary |
| Account Planning | Actively participates in a continuous account planning process, by |
| | coaching the sales representative in assessing customer value as well |
| | as by planning and shaping account strategies. |
| Account Relationship | Identifies the most strategically important accounts, decision |
| Management | makers/influencers and personally develops business relationships |
| | with them. |
| Agent of Change | Challenges the status quo, supports fresh perspectives, tries out new |
| | approaches and enlists support for change initiatives. |
| Accountability | Clarifies expectations and holds people accountable for getting |
| | results, objectively measures outcomes against established goals |
| | while rewarding achievement and confronting poor performance |
| Administration | Completes all administrative tasks that are necessary for effective |
| | management of accounts, the sales group/team, performance |
| | management of its members, as well as sales and organizational |
| | goals. |
| Aligns Selling | Shows competence in bringing organizational groups together to |
| Organization Structures | strategically manage all aspects of the sales process, from finance, to |
| | legal, to IT, and all other necessary components and groups that |
| | ensure the success of customer delivery and satisfaction. |
| Assessing Performance | Proactively gauges salesperson performance against objectives via a |
| | variety of metrics and recognizes significant trends |
| Budgeting | Understands all aspects of the financial requirements for successful |
| | sales process, group/team, and organizational management, including |
| | pre and post-sales activities required to profitably deliver on |
| | promised customer products and/or services, within or under budget |
| | constraints. Understands and follows established budget planning |
| | and management procedures to monitor and control the financial |
| | aspect of projects, resources, and P&L statements; manages to |
| | financial goals; manages billing activities; establishes and tracks |
| | business metrics to ensure efforts lead to desired outcomes |
| Building Best People | Commits time and energy to developing the skills and competencies |
| | of the individuals in one's team, giving them the resources to fulfill |
| | their objectives, and stimulating an environment of success and |
| | growth. |
| Building Partnerships | Works effectively with other groups and functions, shares |
| | information across the enterprise, and considers the impact of |
| | decisions on other departments and groups. |
| Channel Strategy and | Develops customers, processes, products, and offers to, in, and with |
| Development | appropriate and effective channels. |
| Channel-Customer | Understands, utilizes, and matches the appropriate channels to sell to |
| Alignment | and get products and/or services to the correct corresponding |
| | customers. |
| Coaching | Helps subordinates improve selling skills by providing regular |
| | coaching, helping them change behavior, improve performance and |
| | sustain commitment through encouragement, support, collaborative |
| | problem solving, goal setting and feedback. |
| Financial Management | Follows established budget planning and financial management |
| | procedures to develop, monitor, and control the financial aspects of |
| | his/her team. |
| Communicating the Big | Helps others understand why their duties and roles are important and |
| Picture | makes them aware of their impact on larger business issues. |
| Compensation and | Effectively communicates and uses the sales incentive plan to |
| Incentive Plans | motivate, compensate, and recognize individual and team |
| | performance. |
| Competitive Intelligence | Enacts, engages in, or delegates research in order to understand, |
| | analyze, and synthesize the actual or probable behaviors of |
| | competitors that have the potential of standing in the way of, or |
| | capturing the sale of current or future prospects and/or customers. |
| Conflict Resolution | Facilitates conflict resolution between coworkers by surfacing and |
| | clarifying areas of disagreement and by creating an environment |
| | where resolution is possible. |
| Contract Management | Understands all the activities that an enterprise or an individual |
| | engages in, while entering into a business transaction with one or |
| | more trading/sales partners and fulfilling all the obligations of the |
| | terms and conditions agreed upon in the contract. |
| Creating Buy-in | Effectively builds commitment and wins support for initiatives |
| | through personal and professional credibility, trustworthiness, |
| | persuasive communication, stakeholder involvement, and by aligning |
| | expectations. |
| Creating Meaning | Helps others understand why their duties and roles are important, |
| | relating tactics to the overall strategy to expand significance and |
| | make them aware of the bigger picture, reminding people of their |
| | impact, and ties day-to-day activities of the team to larger business |
| | issues. |
| Customer Valuation | Determining customer value via a variety of methods, including data |
| | collection and mining and the relevant behavioral and economic |
| | components of lifetime value, and analysis to integrate these |
| | components into overall measures of customer value in order to |
| | increase efficiencies and make better marketing investments for more |
| | effective targeting and migration to the most productive channels. |
| Continuous | Continuously searches for best practices that improve the |
| Improvement | effectiveness of the sales team |
| Data Capture | Ensures that relevant data (customer, market, competitor, etc.) is |
| Management | captured and kept current. |
| Drive Sales | Drives adoption of all appropriate sales methodologies, tools, and |
| Infrastructure Adoption | capabilities that help the team achieve their objectives |
| Decisiveness | Makes clear-cut decisions without unnecessary delay, even in tough |
| | situations. |
| Delegation | Places trust in others by moving decision-making close to the level |
| | where the work is done and by giving others the responsibility, |
| | authority, independence and support they need to succeed. |
| Developing Business | Develops thorough and far reaching objectives for one's team and/or |
| Plans | business unit, taking into account specific tactics and strategies for |
| | achieving those goals. |
| Developing Structures, | Designs and/or establishes structures, systems, and processes to most |
| Systems, and Processes | effectively achieve the organization's and group's/team's objectives. |
| Develops People | Coaches, mentors, and provides personal motivation and incentive to |
| | increase sales reps' skill sets in all aspects of the sales process. |
| | Passes knowledge and experience to other employees though formal |
| | or on the job training; takes an active role in mentoring or training |
| | programs; puts plans in place to build the skills, abilities, and |
| | experience necessary for the success of individuals and of the |
| | business; provides ongoing review, coaching, and mentoring support; |
| | delegates work to others in order to provide developmental |
| | opportunities. |
| Emphasizes Excellence | Sets challenging goals and high standards of excellence while |
| | refusing to accept mediocre or substandard performance. |
| Empowerment and | Moves decision making to the level where the work is done by giving |
| delegation | others the responsibility, authority, autonomy, and support they need |
| | to succeed. |
| Facilitates Information | Helps to create an environment in which open sharing of information |
| Exchange Between | between sales and sales management occurs, keeping parties “in the |
| Management and | loop” about plans, activities, objectives, recent developments, and |
| Salespeople | progress towards goals is communicated. |
| Fairness | Is objective, fair, and even handed in the administration and |
| | application of policies, procedures, and evaluations. |
| Field Experience | Demonstrates credibility due to his/her successful past experience as |
| | a sales representative. |
| Fosters Channel Partner | Ensures effective use of channel partners by the sales team to |
| Relationships | develop and deliver an effective solution for the customer |
| Funds Management | Allocates budgeted funds efficiently to achieve business goals, using |
| | both financial and human resources efficiently to minimize costs and |
| | maximize benefits. |
| Group Dynamics | Processes the psychological and behavioral forces and inter relations |
| | among group members and the group as a cohesive unit, in order to |
| | get group members to interact with one another, accept rights and |
| | obligations as group members and share a common group identity. |
| Handling Resistance to | Identifies sources of resistance to change and effectively deals with |
| Change | them before they undermine change initiatives. |
| Hiring Top Talent | Identifies skills and competencies required in the role to be filled and |
| | excels at selecting and hiring job candidates who meet and exceed |
| | these criteria |
| Holding Others | Holds people accountable for meeting agreed upon objectives, |
| Accountable | rewarding good performance, and confronting poor performance. |
| Managing Change | Helps the team deal with change by understanding the need, buying |
| | into it, planning, and leading others through the transition |
| Market Savvy | Effectively keeps his/her fingers on the pulse of industry and |
| | customer needs in order to identify new market opportunities |
| Market Analysis | Keeps up on developments outside the organization that may have an |
| | impact on the business, such as trends in the industry, new |
| | technologies, and events in the larger economic and political |
| | environments. |
| Marketing | Demonstrates a thorough understanding of all activities associated |
| | with selling products and/or services, including product and market |
| | strategies, advertising, selling and delivering products/services, |
| | getting the attention of target audiences through the use of a variety |
| | of means, including using slogans, packaging design, endorsements |
| | and general media exposure, as well as the four “Ps” of marketing: |
| | product, place, price and promotion. |
| Mentoring | Gives salespeople hope and inspiration by being an effective role |
| | model, displaying optimism, energy, confidence, enthusiasm, |
| | determination and commitment, especially in tough times. |
| Motivational Skills | Encourages, rewards and recognizes performance and creates greater |
| | effort and positive morale |
| New Product Launch | Executes sales activities before and during new product launches to |
| | maximize the return on investment from those launches. |
| Objectivity | Maintains a realistic perspective and keeps personal biases to a |
| | minimum. |
| Openness to input | Solicits and is genuinely open to personal feedback, differing ideas, |
| | and points of view. |
| Operational Efficiency | Creates and engages the right combination of people, processes, and |
| | technology to enhance the productivity and value of the business |
| | operation, while driving down the cost of routine operations to a |
| | desired level. |
| Organizational | Is alert to events and trends within the organization and considers |
| Awareness | how they might influence the long term performance of the |
| | organization as well as the sales team. |
| People Development | Is committed to the personal development needs of the individuals on |
| | the sales team and ensures that they take advantage of targeted |
| | learning opportunities |
| Performance | Establishes clear goals and priorities, creates project plans and |
| Management | processes to achieve results, monitors progress and addresses |
| | setbacks, and holds people accountable for outcomes. Provides clear |
| | and consistent feedback and encouragement; evaluates individuals' |
| | performance regularly based on clearly communicated objectives; |
| | addresses performance issues in a timely manner; initiates |
| | appropriate and timely action to help others improve performance |
| Praise and Recognition | Recognizes, rewards, and acknowledges others for good |
| | performance. |
| Predictive Modeling | Efficiently and accurately models customer, financial, and sales |
| | behaviors in order to best predict the probability of a sales outcomes. |
| Process Improvement | Clearly and consistently enhances procedures and methodologies to |
| | increase efficiency and increase profitable revenue. |
| Promotion and | Plans and executes promotions and campaigns designed to increase |
| Campaign Management/ | brand equity and achieve sales objectives that result in positive ROI. |
| Execution | |
| Proposal Generation and | Effectively administrates the bid and proposal process, including all |
| Tracking | components such as resource management, time management, |
| | technical expertise management, in order to successfully submit |
| | quality proposals as well as track proposals by sales rep and |
| | customer. |
| Provide Feedback | Provides useful and timely positive and negative feedback to |
| | subordinates to help them improve performance |
| Provides Shared Vision | Persuades sales reps to work toward their vision of the future, |
| | creating, selling, and driving the strategy of the team and/or |
| | organization at large by pushing for action and instilling a sense of |
| | urgency in achieving team and/or organizational goals. |
| Quota setting | Effectively manages the process of establishing reasonable yet |
| | challenging sales quotas, considering the business, industry, type and |
| | size of the sales organization, and product and/or service being sold, |
| | focusing on such areas as corporate revenue goals, historical revenue |
| | performance, current sales coverage models, planned increases in |
| | sales headcount, the introduction of new products and/or services, |
| | current market share, and stretch targets. |
| Resource Management | Sets priorities, plans, and coordinates several work activities to |
| | complete work efficiently; identifies critical paths associated with |
| | work completion; manages resources and time to handle unexpected |
| | problems and issues as they arise; delegates wok to others on order to |
| | effectively utilize resources; obtains and manages resources so that |
| | work objectives are accomplished on time and within budget; |
| | coordinates use of resources within the team, office, region, or form |
| | to ensure delivery of effective and timely services |
| Retaining Top Talent | Minimizes undesirable attrition by assessing the organizational |
| | climate, employee engagement and attrition risk, and then taking |
| | action where needed to retain top talent. |
| Risk Management | Ability to analyze the relative costs, benefits, risks and opportunities |
| | associated with various alternatives. This includes assessing the |
| | feasibility of alternatives, the effect on budget and schedule, and the |
| | effect on the quality of products and services. |
| Shielding | Filtering and/or protecting one's sales team from non value added |
| | corporate requests. |
| Strategic ability | Effectively defines a long term plan of action designed to achieve the |
| | group's/team's goal(s) |
| Strategic Focus | Thinks strategically, creates an ongoing, dynamic strategic planning |
| | process, and communicates the organization's and group's/team's |
| | long term direction. |
| Team Selling | Effectively uses and manages the entire sales team, assigning roles |
| | and responsibilities in order to coordinate, strategize, and present a |
| | cohesive group front when approaching and selling into customer |
| | organizations. |
| Teambuilding | Models and encourages teamwork by fostering cooperation, |
| | communication, trust, shared goals, interdependency, and mutual |
| | accountability and support. |
| Technology Acceptance | Effectively utilizes sales force automation, customer relationship |
| and Use | management and all other technological tools that enhance sales |
| | force effectiveness |
| Territory Management | Assesses current and future market opportunities in the target |
| | geography or customer set and assigns resources to capture these |
| | opportunities to meet and/or exceed goals |
| Training and | Provides opportunities for sales rep/team learning and enhancement |
| Development | of their skills, giving them greater access to resources in order to |
| | build their confidence and knowledge to accomplish their required |
| | goals. |

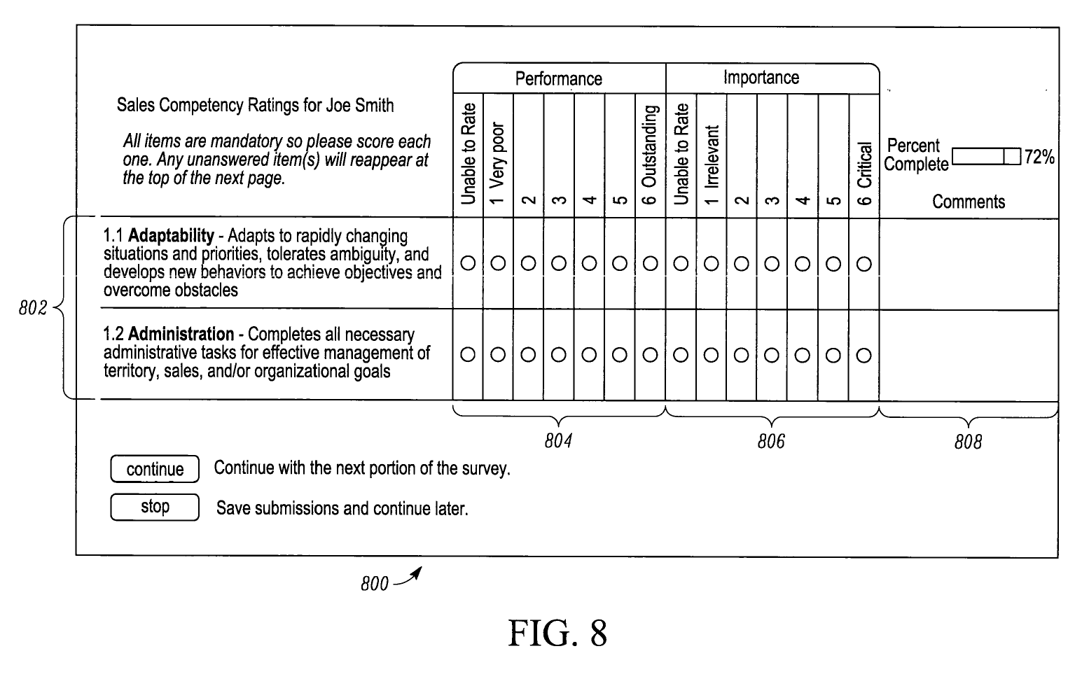

As in the case of the personality assessment, the questions associated with the competency assessment are designed to provide a comprehensive picture of sales representatives' and managers' competencies on individual levels while the aggregate informs on the entire sales force. In this manner, the competency assessment data provides a relevant basis for analysis and comparing within-group norms as well as industry-level, geographic-level data (or any other comparisons deemed relevant by clients). In this same vein, individuals may also be compared against such group norms. Once again, in a current implementation, completion time is approximately 45-60 minutes, although this is variable depending on the length of comments (see FIG. 8), if any, provided by the respondent.

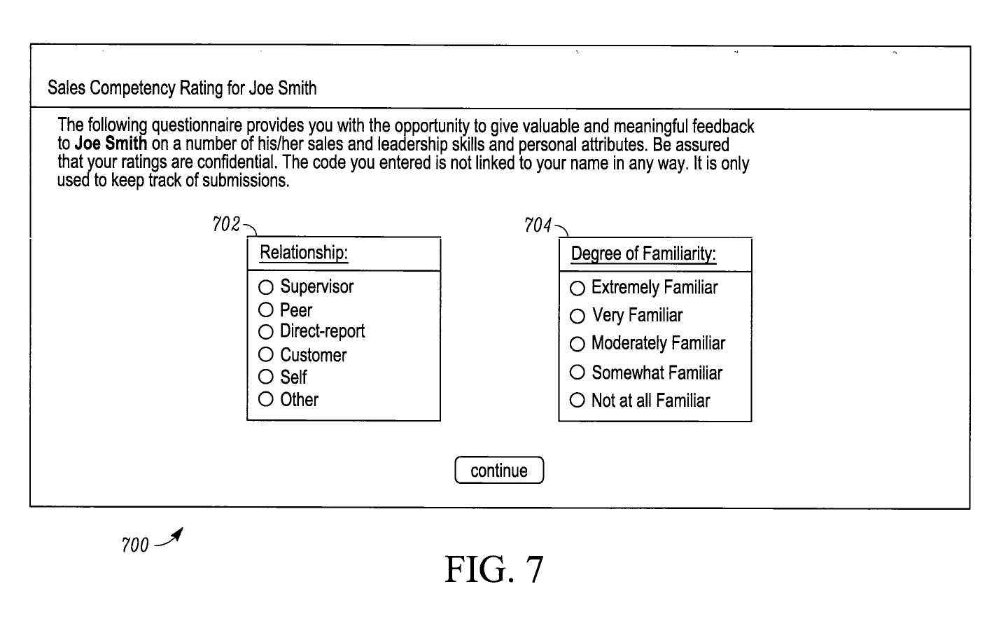

One aspect of competency assessments is that, when individuals are assessed, they are asked not only to self-assess, but to also identify others to assess them as well. That is, they are asked to identify any number of subordinates, peers, superiors, or customers to rate them, although at least 5 to 10 total reviewers are recommended. This is illustrated in FIG. 7 where a user interface display 700 is illustrated. As shown, the display 700 includes various options 702 that allow the respondent to identify his/her relationship with the person being assessed. Similarly, familiarity options 704 are also provided that allow the respondent to specify how familiar he/she is with the person being assessed. (Of course, when a respondent identifies his/her relationship as “Self”, the familiarity options are disabled.) In one embodiment, the selections from the relationship options 702 and familiarity options 704 are used to establish a weighting factor (as noted above) that is representative of the degree to which the respondent's assessment data should be incorporated into an individual's overall assessment. For example, customers might not get as much weight as superiors or peers, for example, since it can be assumed that someone choosing customers would only choose those that are inclined to favorably assess the individual being evaluated. Note that, although particular relationships 702 and familiarity degrees 704 are illustrated in FIG. 7, it is understood that other relationships or familiarity expressions may be used depending on a variety of factors, including the particular context and the organization being assessed.

FIG. 8 illustrates another example of a user interface display 800 related to the collection of competency assessment data. Once again, a plurality of questions 802 are provided, portions or all of which may be deemed mandatory. Unlike the personality assessment questions 702, each of the competency assessment questions 802 is rated in two ways: according to a performance scale 804 and an importance scale 806. In the illustrated example, performance is rated on a 6-point scale 804, from a rating of 1 (“Very Poor”) to 6 (“Outstanding”). The respondent evaluates the person's current performance concerning the specific competency under consideration. If the respondent is unable to rate the performance of the person with regards to the competency in question, he or she can click an “Unable to Rate” button. As further shown in the illustrated example, level of importance of a particular competency is rated on a 6-point scale 806, from a rating of 1 (“Irrelevant”) to 6 (“Critical”). When completing the importance ratings, the respondent evaluates how important the competency under consideration is with regard to the person's role as a sales representative or sales manager. Once again, if the respondent is unable to rate the level of importance of the competency in question as it relates to the person's role, he or she can click the “Unable to Rate” button. Finally, a comment section 808 is provided for each question 802. The comments section 808 allows the respondent to explain his or her ratings, particularly if the rating of the individual is particularly critical or favorable. Comments can provide the individual being assessed with an understanding of what needs to be done differently to improve performance. Comments can be analyzed and/or included in reports to show specific themes for each individual as well as the aggregate sales organization.

Regarding the behaviors assessment, in an embodiment, the collected assessment data comprises answers to questions concerning how the individual spends his or her time engaged in particular activities. Once again, while specific activities are set forth below, it is understood that other activities concerning sales performance could be equally employed as a matter of design choice and that various subsets of the listed activities may be employed. Table 5 summarizes some examples of categories and subsections for time/activity entry. It is noted that the specific time/activity categories employed will typically be a function of the type of organization being assessed are therefore entirely customizable by client situation.

TABLE 5

| Category | Subsection | Specific Activities |
|---|---|---|
| Sales-related direct | Initial customer-contact/ | |
| customer-contact | cold calls | |
| activities | Pre-sales activities - | Lead identification via customer |
| | Prospects and existing | contact |
| | customers | Lead qualification via customer |
| | | contact |
| | | Meeting scheduling via customer |
| | | contact |
| | Sales activities - Prospects | Sales calls and/or presentations (by |
| | and existing customers | telephone or email) |
| | | Sales calls and/or presentations (face- |
| | | to-face) |
| | | Building customer executive coaches |
| | | Negotiations and follow-up |
| | | Closing/order entering |
| | | Informal relationship-building/ |
| | | networking |
| | Post-sales activities - | Products/service implementation |
| | Prospects and existing | Customer service and support |
| | customers | |
| Sales-related non- | Cold call activities | Research for cold calls |
| customer contact | | Creating call plans for cold calls |
| activities | | Documenting notes for cold calls |
| | Pre-sales activities - | Product and customer research |
| | Prospects and existing | Prospect/customer identification |
| | customers | Creating call plans |
| | | Competitive and industry research |
| | | Creating sales, account, and |
| | | opportunity plans |
| | | Creating meeting/presentation |
| | | materials |
| | | Territory planning and analysis |
| | | Rehearsing visits |
| | Sales activities - Prospects | Travel |
| | and existing customers | Documenting notes for calls |
| | | Proposal/pricing creation |
| | | Contract generation/modifications |
| | | Lining up internal resources |
| | | Defining and refining customer |
| | | solutions |
| | | Getting approvals required to submit |
| | | initial proposals |
| | | Redrafting proposals after receiving |
| | | customer feedback |
| | | Getting approvals required to submit |
| | | proposals after receiving customer |
| | | feedback |
| | Post-sales activities - | Account setup |
| | Prospects and existing | Order tracking |
| | customers | Win analysis |
| | | Loss analysis |
| | | Handling customer service (billing/ |
| | | AR) issues |
| Internal Non-sales- | Learning | Systems and/or technical training |
| related activities | | Sales training |
| | | Product training |
| | | Other training |
| | Internal activities | Sales/team meetings discussing sales |
| | | issues |
| | | Sales/team meetings discussing non- |
| | | sales issues |
| | | One-on-one meetings with sales |
| | | manager discussing sales issues |
| | | One-on-one meetings with sales |
| | | manager discussing non-sales issues |
| | | Receiving coaching |
| | | Providing coaching |
| | | Updating sales management |
| | | Generating and updating sales |
| | | forecasts and reports |
| | | Ad-hoc and regular reporting |
| | Administrative activities | Compensation tracking |
| | | Other administrative activities |
| | | Attending company-wide meetings |
| | | and trade shows |

The activities list set forth in Table 5 is also dependent upon role, i.e. sales managers engage in some activities that overlap with sales representatives but also engage in entirely unique activities. The same is true for sales representatives, and the data entry screens are changed per role, per client, per industry, or as needed depending on context and complexity of the sales role. Regardless of the particular implementation required for a given organization, the categories are designed to elicit very specific data regarding how a persons uses his/her time engaged in various activities, and thus inform on both the effectiveness and efficiency with which sales representatives and managers complete the tasks necessary for their respective sales roles. In a current implementation, the entire behavior assessment should take approximately 45-60 minutes to complete, depending on the respondent's speed and the length of breaks.

In an embodiment, the collection of behavior assessment data begins with the respondent answering a series of demographic questions using, for example, pre-populated pull down menus, i.e., what role the person plays in sales in his/her organization, how long he/she has been with the organization, how long he/she has been in a sales role at the organization, how long he/she has held “quota-bearing” sales representative roles in his/her entire career, and how long he/she has held sales manager roles in his/her entire career. Other, more “pure” demographic data, such as age, gender, country of origin, etc. may likewise be collected. It will be appreciated that a greater or less number of demographic-type questions or questions covering different demographic aspects may be employed as necessary.

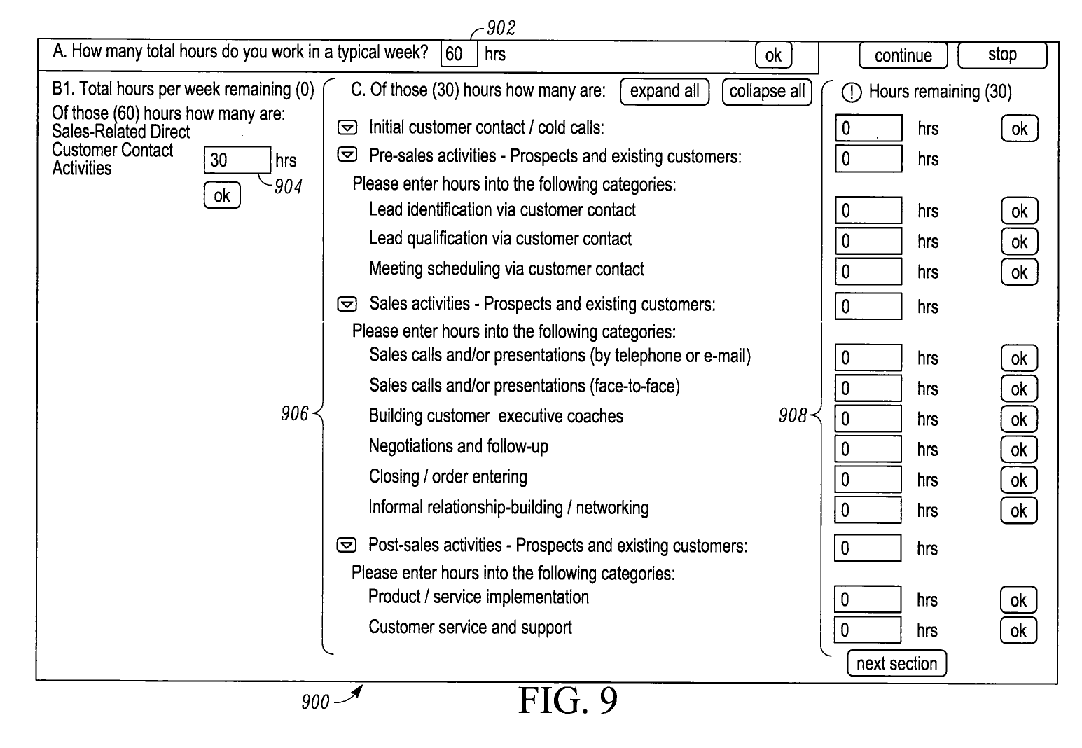

Thereafter, the respondent is asked to detail how much time it takes for him/her to complete all of the tasks necessary to complete his/her role as either a sales representative or sales manager. In an embodiment, this may be achieved by first asking the respondent how many total hours he/she works in a typical week, month or year. This total number of hours may then be broken down into specific categories, such as those described above, e.g., the number of hours dedicated to: sales-related direct customer-contact activities, sales-related non-customer contact activities, and internal non-sales-related activities. These steps are illustrated in FIG. 9, which illustrates another example (on a weekly basis) of a user interface display 900 comprising a total time entry field 902 and, in this example, one category-specific time entry field 904. Completion of this latter field 904 causes the display of additional questions 906 that require the respondent to further parse the number of hours he/she works on specific activities using the activity time entry fields 908.

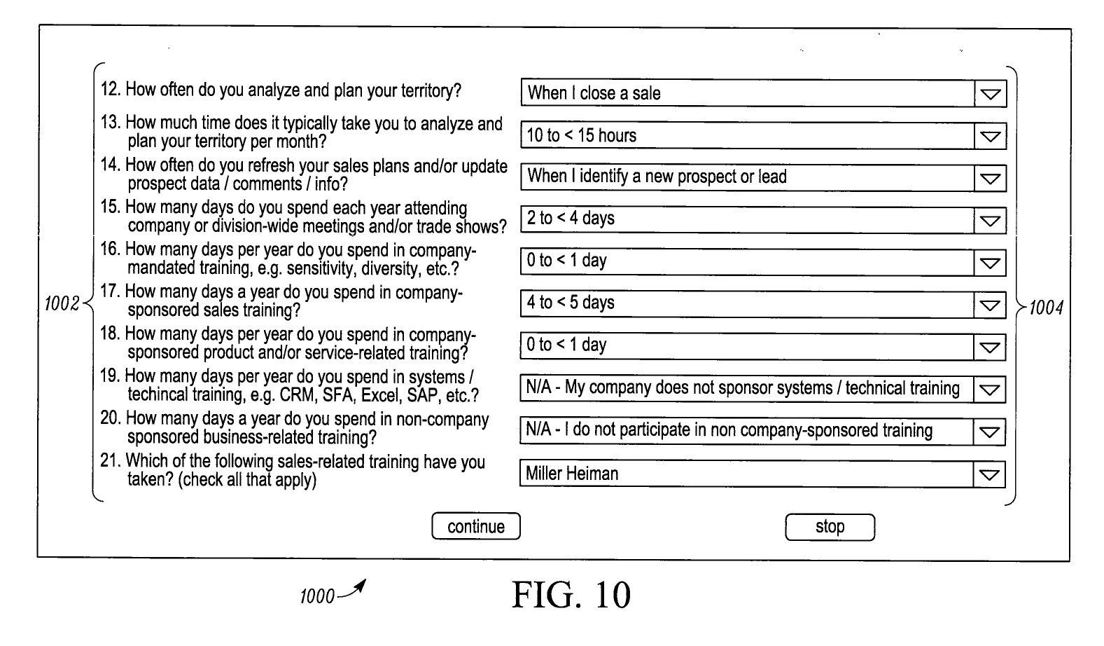

Once the number of hours spent on specific activities has been entered, the respondent may be requested to provide, in an embodiment, a variety of both optional and required additional demographic information that can be customized dependent upon an organization's needs. FIG. 10 illustrates an example of a user interface display 1000 for this purpose. As shown, a variety of question 1002 may be provided that can be answered, in this example, using pre-populated pull down menus 1004. Those having skill in the art will appreciate that other input mechanisms, such as buttons, etc. may be equally employed in place of or in conjunction with the pull down menus 1004.

Furthermore, in the embodiments described above, a staged approach to collecting assessment and demographic information is described. That is, specific portions of respondent demographic data is collected contemporaneously with respondent's assessment data. In this staged approach, it is preferable to obtain the complete the personality assessment portion first, followed by the competency and behaviors portions in sequence. In an alternative embodiment, it is necessary for the respondent to first complete the demographic data capture portion before being allowed to answer any of the assessment (personality, competency and/or behavior) portions. In this manner, a respondent's demographics can be correlated with all of the assessments they've completed. That is, in case a respondent fails to complete one or more of the assessments, the collected demographics data may still be used when processing that portion of the assessments that were completed. As such, valuable data may be preserved for use even if the entire process is not completed.

Referring once again to FIG. 4, the techniques described above may be used, at block 402, to collect the personality, competency and behavior assessment data from one or, more typically, a plurality of individuals for an organization. Thereafter, the individual assessment data may be optionally aggregated across any desired categories at block 404. As noted above, such categories may be defined according to various parameters such as geographic regions, sales type (e.g., large industrial versus individual consumer), product lines, etc. Various data mining techniques and tools for this purpose are well known in the art. Thereafter, at block 406, the overall individual assessment data (comprising the personality assessment data, the competency assessment data and the behavior assessment data) may be compared with high sales performer benchmark data.

In an embodiment, high sales performer benchmark data is determined by first identifying, within a given sales organization, those sales persons considered to be high sales performers. This can be through a variety of methods such as receiving the identifications from the organization's management or through a more complex process of evaluating quantitative (and, optionally, qualitative) sales performance data for each sales person provided by the organization. Regardless of how they are identified, the high sales performers are assessed using the above-described techniques to establish baselines values for each of the assessment categories, i.e., personality, competency and behavior, as well as specific portions of each assessment category, i.e., down to the individual question level. The baseline values for any given assessment category may be provided by combining the individual assessment data for the identified high performers, e.g., straight or weighted averages or any other suitable combination technique. These baseline values across the identified high sales performers are then used as the benchmark data. Once obtained, the benchmark data may be used for comparison purposes against both individual sales persons and the aggregated groups as desired.

In an alternate embodiment, the high sales performer benchmark data is determined by first obtaining all of the assessment data for each individual, i.e., high performers as well as all other personnel being assessed. Thereafter the process of determining baseline values is performed based on that portion of the overall assessment data corresponding to subsequently identified high sales performers. This is done because, as known in the art, larger numbers of respondents improves the reliability and validity of the subsequent factor analysis, i.e., the process of identifying those factors most likely to predict sales performance. In this manner, those components or aspects of high performance for the identified high performers may be compared with the overall results to ensure its reliability.

Thereafter, at block 408, processing continues where the comparison results are used to identify performance improvement opportunities. That is, the differences between an individual's assessment results (or an aggregated group's assessment results) and the high sales performer benchmark data will reveal specific aspects within each assessment category where the individual (or group) under-performs the high sales performers. To the extent that assessment results of the high sales performers represent optimal performance, it may be assumed that such comparison differences represent the best opportunities for improving overall sales performance. Based on the identified performance improvement opportunities, one or more specific actions may also be identified for the individual (or group) at block 408. Such specific actions, when carried out, are selected to help the individual (or group) improve performance in the specifically identified assessment aspects. On an individual level, such actions may include, but are not limited to, specific coaching, methods for improving efficiency through the use of technology, particular training courses, etc. On a group level, such actions may include, but are not limited to, organization-wide technology changes (e.g., customer relationship management (CRM) implementation), organization structure changes, organizational alignment changes, etc. Once identified, the specific actions may be optionally implemented at block 410.

In parallel with blocks 408 and 410, processing may also continue at block 412 where various reports may be generated. In accordance with the comparisons performed at block 406, the reports generated at block 412 may be comprise information concerning an individual's overall assessment data and/or an aggregated group's overall assessment data. Furthermore, the reports may illustrate the comparison of the individual/group assessment data against the high sales performer benchmark data. Various examples of this are illustrated with respect to FIGS. 11-14.

FIG. 11 illustrates an example of a user interface display 1100 for a report concerning an individual's personality assessment data. As shown, both the individual's personality assessment data 1102 and high sales performer benchmark data 1104 (left-hand score column) are illustrated in numerical form. As further shown, bar charts 1106 illustrating the respective individual and high sales performer scores (relative to an absolute scoring scale 1108) for each personality aspect 1110 are also provided to visually illustrate the differences. Of equal importance, a gap score 1112 (right-hand score column) is further provided to clearly indicate the differences between the individual's scores and high performer scores. The gap scores 1112 may also be indicated visually 1114, in the illustrated example, by an interval delineated by a dotted vertical line (corresponding to the individual's score) and a solid vertical line (corresponding to high performer score) with a directional arrow indicating the polarity of the gap score (right-facing arrow indicating the individual's score lags the high performer score; left-facing arrow indicating the individual's score leads the high performer score).

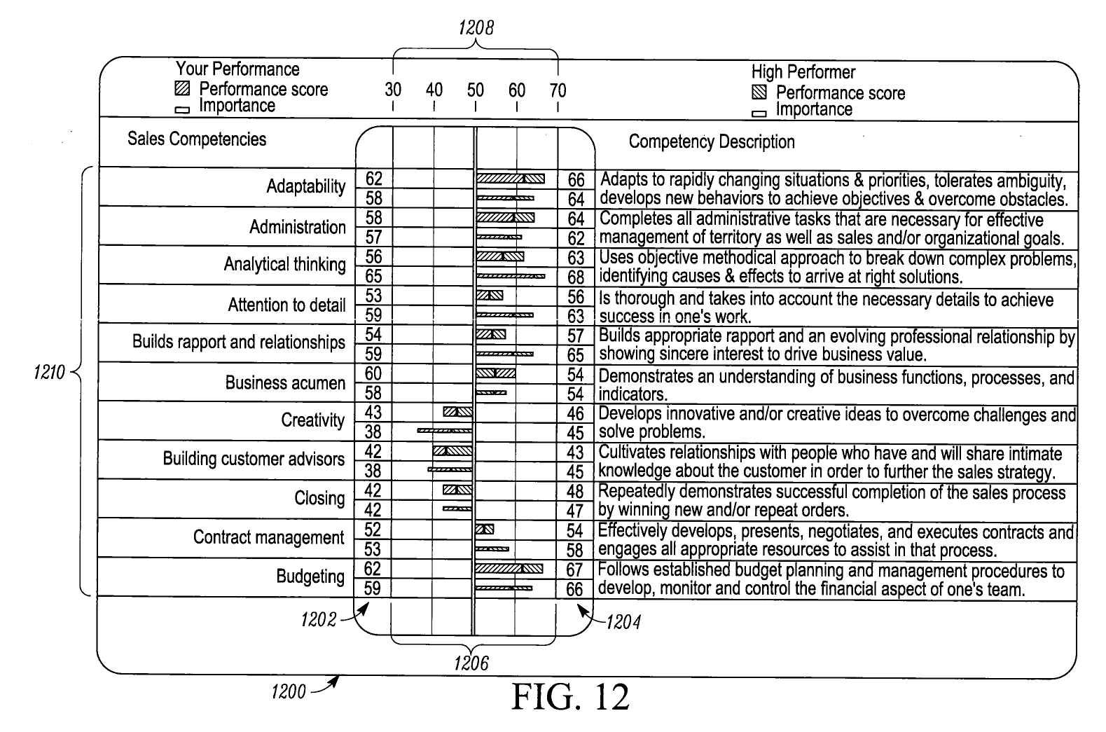

FIG. 12 illustrates an example of a user interface display 1200 for a report concerning an individual's competency assessment data 1202 (left-hand score column) as compared to high sales performer benchmark data 1204 (right-hand score column). Note that both the individual and high sale performer competency assessment data 1202, 1204 is further broken down according to the performance and importance ratings described above. Once again, bar charts 1206 illustrating the respective individual and high sales performer scores (relative to an absolute scoring scale 1208) for each competency 1210 are also provided to visually illustrate the scoring gaps. In the illustrated example, performance scores are illustrated using thicker bars, whereas importance scores are illustrated using thinner bars, although it is understood that any convenient graphical illustration method could be employed for this purpose. Note that the display 1200 in this example uses a different format for visually illustrating the gap scores as compared to that used in FIG. 11 (overlaid bars versus interval lines and directional arrows); those having ordinary skill in the art will appreciate that either or both techniques (or still other techniques not shown) may be employed in any of the displays illustrated herein as a matter of design choice and that the instant disclosure is not limited in this regard.

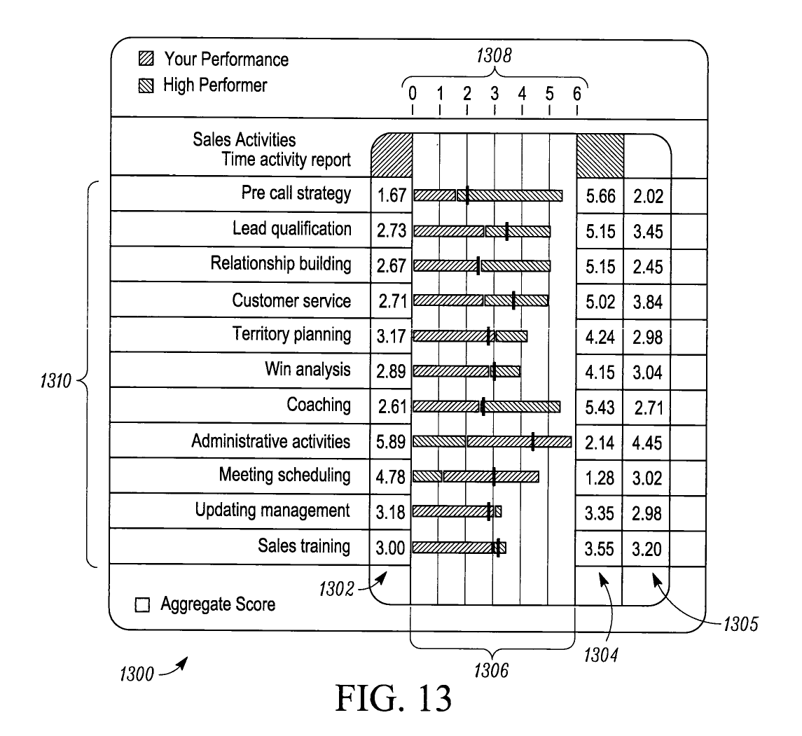

FIG. 13 illustrates an example of a user interface display 1300 for a report concerning an individual's behavior assessment data 1302 (left-hand score column) as compared to high sales performer benchmark data 1304 (inner right-hand score column). In this example, aggregated behavior assessment data 1305 (outer right-hand score column) is also provided. Note that aggregate score could be across any desired group of individual sales persons, as noted above. As before, bar charts 1306 illustrating the respective individual and high sales performer scores (relative to an absolute scoring scale 1308) for each specific activity 1310 are also provided to visually illustrate the differences. Note the inclusion, in this example, of the heavy vertical lines displayed within the bar charts corresponding to the respective aggregated scores.

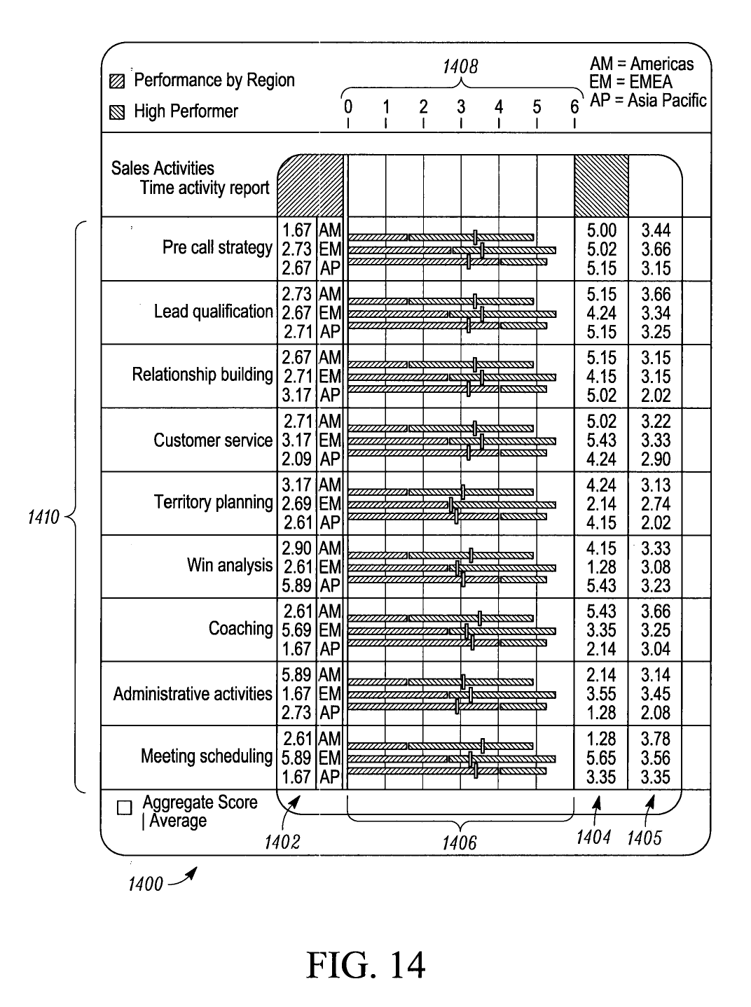

FIG. 14 illustrates an example of a user interface display 1400 for a report concerning various behavior assessment data for a variety of aggregated groups, in this example, according to geographic region. Once again, each aggregated group's assessment data 1402 (left-hand column) is provide along with high sales performer benchmark data 1404 (inner right-hand score column). In this example, the average score for each aggregated group 1405 (outer right-hand score column) is also provided. As in FIG. 13, each aggregated group's scores are illustrated (relative to an absolute scoring scale 1408) in comparison with the high sales performer benchmark data using bar charts 1406, with the aggregated group average score indicated by a heavy vertical line within each of the bar charts. Further still, an overall aggregated average for each activity across all groups is illustrated by the dotted vertical line crossing each group's bar chart.

As can be seen from the examples illustrated in FIGS. 11-14, the reports illustrate an overall gap map that shows where both individual and overall (i.e., organization wide) improvement needs to take place for competencies and time/activities in order to shift the organizational curve. It should be noted that there is no right or wrong sales personality. Personality traits cannot be changed (or are very difficult to do so, if at all), but they do inform on how one behaves and learns new skills, and is important, at the very least, in terms of coaching at the individual and aggregate levels. If one knows the overall aggregate sales personality map of an organization, for example, it is much easier to devise and target specific communication plans that will be much more likely to be greeted with success. It is also important in terms of prediction for the other components of high performance sales, as discussed in greater detail below relative to FIG. 5. While FIGS. 11-14 illustrate specific instances of report formats, those having ordinary skill in the art will, again, appreciate that a variety of presentation formats may be employed to present substantially the same information, and that the instant disclosure is not limited in this regard.

Referring once again to FIG. 4, processing may continue at block 414 where one or more of the generated reports are provided to various entities such as, by way of non-limiting example, an individual's manager or supervisor. For example, using the web server technology described above, the various reports may be made available as web pages to those persons authorized to view them. Further still, such reports may be specifically sent to certain entities using, for example, email delivery. Regardless of the delivery channel used, such reports may be provided to individual sales personnel (particularly those reports concerning his/her individual assessment data) or those associated with an individual sales person as described above.

Once the analysis (of blocks 408 and 410) and reporting (412, 414) is accomplished, processing continues at block 416 where it is determined if additional re-assessment, of certain individuals and/or the entire organization is desired. If so, processing continues at block 402 where the assessment, analysis and reporting processes are repeated. For example, following implementation of the various specific actions identified at block 410, it may be desirable at a later time to re-assess to determine what actual improvements have been made (and/or to determine how high sales performer benchmark data has changed over time). With the subsequent assessment data gathered, all of the comparisons described above could be additionally compared over time.

Referring now to FIG. 5, predictive processing in accordance with an embodiment is further described. Beginning at block 502, individual personality, competency and behavior assessment data is obtained for a given organization's sales personnel using the techniques described above. Thereafter, at block 504, predictive characteristics for high sales performers are identified based on the assessment data obtained at block 502. To identify the predictive characteristics, high sales performers within the organization may be identified using the previously-described techniques. Based on the identified high sales performers, various known statistical techniques may be applied to the collective assessment data (from block 502) of the high sales performers, including but not limited to the above-identified analysis techniques (e.g., regression modeling, ANOVA, ANCOVA, etc.). Using such techniques, those characteristics (e.g., personality traits, particular competencies or time/activity behaviors, or combinations thereof) that best correlate with high sales performance are identified as the predictive characteristics. It is desirable that the predictive characteristics be drawn, at least in part, from each of the three assessment categories, i.e., that respective portions of the predictive characteristics are drawn from the personality, competency and behavior categories. For example, within a given organization, predictive characteristics of a high sales performer may include a personality characterized by high levels of curiosity coupled with a competitive streak, competencies characterized by strong relationship building and networking skills and behaviors characterized by strong negotiating skills and post-sale contact. Of course, the predictive characteristics will almost certainly vary across organizations and industry types or cultures.

Thereafter, processing continues at block 506 where assessment data for an individual sales person is obtained, which assessment data may be limited to any one or more of the above-described categories, i.e., personality, competency and behavior. The assessment data of block 506 may comprise the data previously obtained at block 502, or may be subsequently-obtained data (again using the techniques described above) for an individual that may or may not have participated at block 506. Thereafter, at blocks 508-516, the individual assessment data obtained at block 506 may be used to predict various characteristics of the individual sales person based on the predictive characteristics identified at block 504.

Thus, at block 508, it is determined whether personality assessment data is available for the individual. If so, processing may continue at block 510 where either or both of competency characteristics and behavior characteristics may be predicted based on the personality assessment data and the predictive characteristics. This is accomplished by comparing the individual's personality assessment data with that portion of the predictive characteristics corresponding to personality assessments. To the extent that the individual's personality assessment data correlates (or does not correlate) with the personality-related portion of the predictive characteristics, the likely degree of correlation between the individual's competency and/or behavior characteristics may be predicted. For example, the comparison may demonstrate that, for a given individual, his/her assessment data maps, with A % confidence, to B % of the personality assessment data of a high performer with certain gaps identified and that, therefore, there is a C % likelihood that the individual will demonstrate the competencies of a high sale performer and a D % likelihood that the individual will demonstrate the behaviors of a high sale performer.

If no personality assessment data is available for the individual, processing may continue at block 512 where it is determined if behavior assessment data is available for the individual. If so, essentially the same process described above may be applied, block 514, to the behavior assessment data, using another portion of the predictive characteristics, to predict competency characteristics for the individual. If no behavior assessment data is available, processing may continue at block 516 where the above-described predictive process is applied to competency assessment data, using yet another portion of the predictive characteristics, to predict behavior characteristics for the individual. It is noted that, while it may be possible to predict personality characteristics from either/both of competency and behavior assessment data, it is generally not viewed as a useful procedure.

While the description of FIG. 5 was based on the prediction of characteristics for individuals, the same techniques could be applied to aggregated assessment data to predict characteristics of a group of sales personnel. Such predictive techniques may be beneficially used in a number of ways. For example, when making new hire decisions, personality assessment data may be obtained as part of the interview process and then used to predict the likelihood that the candidate would exhibit other high sales performer characteristics. In a similar vein, such predictions could be used when making promotion/demotion/termination decisions. Further still, such predictions could be used for determining the likelihood of CRM adoption overall, likelihood of strategic success based on sales force changes, etc. Essentially, the predictive techniques taught herein may be beneficially applied to any decision process in which it would be beneficial to develop performance expectations of an individual or group.

As described above, the instant disclosure describes systematic, repeatable and scalable techniques for assessing sales force personnel in furtherance of overall sale force performance improvement. This is achieved through the collection of personality, competency and behavior assessment data using a computer-based user interface. Based on individual (or aggregated) assessment data, comparisons with high sales performer benchmark data may be undertaken to identify performance improvement opportunities one or more specific actions to be taken in furtherance of the identified improvement opportunities. On an organizational level, such techniques may be used to understand the differences between low, core, and high performers at both representative and manager levels, while also showing how the assessed categories interact in order to come up with a predictive model that will beneficially shift the performance curve (as well as the ratios within the curve) within the organization. Further still, the assessment data may be used to identify predictive characteristics of high sales performers, which thereafter facilitate predictions concerning the likelihood of high sales performance for an individual or group. For at least these reasons, the above-described techniques represent an advancement over prior art teachings.

While particular preferred embodiments have been shown and described, it will be obvious to those skilled in the art that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. A method for improving sales performance, the method comprising:
obtaining, via at least one computer-implemented interface, personality assessment data, behavior assessment data and competency assessment data for a sales person to provide overall individual assessment data;
comparing the overall individual assessment data with high sales performer benchmark data to identify performance improvement opportunities; and
identifying, based on the performance improvement opportunities, one or more specific actions for at least the sales person.

2. The method of claim 1, further comprising:
identifying at least one high sales performer;
obtaining personality assessment data, behavior assessment data and competency assessment data for the at least one high sales performer; and
determining the high sales performer benchmark data based on the personality assessment data, behavior assessment data and competency assessment data for the at least one high sales performer.

3. The method of claim 1, wherein comparing the overall individual assessment data with the high sales performer benchmark data provides individual comparison results, the method further comprising:
generating a report comprising information concerning the overall individual assessment data and the individual comparison results.

4. The method of claim 3, further comprising:
sending the report to at least one of the sales person and an individual associated with the sales person.

5. The method of claim 1, further comprising:
subsequent to implementation of the one or more specific actions, obtaining, via the computer-implemented interface, subsequent personality assessment data, subsequent behavior assessment data and subsequent competency assessment data for the sales person to provide subsequent overall individual assessment data; and
determining a level of change by the sales person based on the overall individual assessment data and the subsequent overall individual assessment data.

6. The method of claim 1, further comprising:
obtaining additional overall individual assessment data comprising additional personality assessment data, additional behavior assessment data and additional competency assessment data, from a plurality of sales persons, wherein the sales person and the plurality of sales persons are affiliated with an organization;
aggregating the additional overall individual assessment data and the overall individual assessment data to provide aggregated assessment data;
comparing the aggregated assessment data with the high sales performer benchmark data to identify additional performance improvement opportunities; and
identifying, based on the additional performance improvement opportunities, one or more additional specific actions for the sales person and the plurality of sales persons.

7. The method of claim 6, wherein comparing the aggregated assessment data with the high sales performer benchmark data provides aggregated comparison results, the method further comprising:
generating a report comprising information concerning the aggregated comparison results; and
sending the report to at least one of the sales person and an individual associated with the sales person.

8. The method of claim 1, wherein obtaining the personality assessment data, the behavior assessment data and the competency assessment data for the sales person further comprises soliciting at least one of the sales person and an individual associated with the sales person.

9. An apparatus for improving sales performance, comprising:
at least one processing device; and
at least one storage component, in communication with the at least one processing device, having stored thereon instructions that, when executed by the at least one processing device, cause the at least one processing device to:
provide a graphical user interface to at least one user terminal in communication with the apparatus;
obtain, via the graphical user interface, personality assessment data, behavior assessment data and competency assessment data for a sales person to provide overall individual assessment data;
compare the overall individual assessment data with high sales performer benchmark data to identify performance improvement opportunities; and
identify, based on the performance improvement opportunities, one or more specific actions for at least the sales person.

10. The apparatus of claim 9, the at least one storage component further comprising instructions that, when executed by the at least one processing device, cause the at least one processing device to:
obtain identities of at least one high sales performer;
obtain personality assessment data, behavior assessment data and competency assessment data for the at least one high sales performer; and
determine the high sales performer benchmark data based on the personality assessment data, behavior assessment data and competency assessment data for the at least one high sales performer.

11. The apparatus of claim 9, the at least one storage component further comprising instructions that, when executed by the at least one processing device, cause the at least one processing device to:
compare the overall individual assessment data with the high sales performer benchmark data to provide individual comparison results; and
generate a report comprising information concerning the overall individual assessment data and the individual comparison results.

12. The apparatus of claim 11, the at least one storage component further comprising instructions that, when executed by the at least one processing device, cause the at least one processing device to:
send the report to at least one of the sales person and an individual associated with the sales person.

13. The apparatus of claim 9, the at least one storage component further comprising instructions that, when executed by the at least one processing device, cause the at least one processing device to:
obtain, subsequent to implementation of the one or more specific actions, subsequent personality assessment data, subsequent behavior assessment data and subsequent competency assessment data for the sales person to provide subsequent overall individual assessment data; and
determine a level of change by the sales person based on the overall individual assessment data and the subsequent overall individual assessment data.

14. The apparatus of claim 9, the at least one storage component further comprising instructions that, when executed by the at least one processing device, cause the at least one processing device to:
obtain additional overall individual assessment data, comprising additional personality assessment data, additional behavior assessment data and additional competency assessment data, from a plurality of sales persons, wherein the sales person and the plurality of sales persons are affiliated with an organization;
aggregate the additional overall individual assessment data and the overall individual assessment data to provide aggregated assessment data;
compare the aggregated assessment data with the high sales performer benchmark data to identify additional performance improvement opportunities; and
identify, based on the additional performance improvement opportunities, one or more additional specific actions for the sales person and the plurality of sales persons.

15. The apparatus of claim 14, the at least one storage component further comprising instructions that, when executed by the at least one processing device, cause the at least one processing device to:
compare the aggregated assessment data with the high sales performer benchmark data to provide aggregated comparison results;
generate a report comprising information concerning the aggregated comparison results; and
send the report to at least one of the sales person and an individual associated with the sales person.

16. The apparatus of claim 9, the at least one storage component further comprising instructions that, when executed by the at least one processing device, cause the at least one processing device to:
obtain the personality assessment data, the behavior assessment data and the competency assessment data for the sales person by soliciting at least one of the sales person and an individual associated with the sales person.

17. A method for assessing characteristics of a sales person, the method comprising:
obtaining, via at least one computer-implemented interface, personality assessment data, behavior assessment data and competency assessment data for each of a plurality of sales persons affiliated with an organization;
identifying, based on the personality assessment data, the behavior assessment data and the competency assessment data for each of the plurality of sales persons, predictive characteristics for high sales performers;
obtaining, via the at least one computer-implemented interface, any one of personality assessment data, behavior assessment data and competency assessment data for an individual sales person;
where the personality assessment data for the individual sales person is obtained, predicting at least one of behavior characteristics and competency characteristics for the individual sales person based on the personality assessment data for the individual sales person and at least a first portion of the predictive characteristics;
where the behavior assessment data for the individual sales person is obtained, predicting competency characteristics for the individual sales person based on the behavior assessment data for the individual sales person and at least a second portion of the predictive characteristics; and
where the competency assessment data for the individual sales person is obtained, predicting behavior characteristics for the individual sales person based on the competency assessment data for the individual sales person and at least a third portion of the predictive characteristics.

18. The method of claim 17, wherein the individual sales person is being considered for affiliation with the organization when obtaining any one of the personality assessment data, the behavior assessment data and the competency assessment data for the individual sales person.

19. The method of claim 17, wherein the individual sales person is affiliated with the organization and being considered for a personnel change when obtaining any one of the personality assessment data, the behavior assessment data and the competency assessment data for the individual sales person.

20. An apparatus for assessing characteristics of a sales person, comprising:
at least one processing device; and
at least one storage component, in communication with the at least one processing device, having stored thereon instructions that, when executed by the at least one processing device, cause the at least one processing device to:
provide a graphical user interface to at least one user terminal in communication with the apparatus;
obtain, via the graphical user interface, personality assessment data, behavior assessment data and competency assessment data for each of a plurality of sales persons affiliated with an organization;
identify, based on the personality assessment data, the behavior assessment data and the competency assessment data for each of the plurality of sales persons, predictive characteristics for high sales performers;
obtain, via the graphical user interface, any one of personality assessment data, behavior assessment data and competency assessment data for an individual sales person;
where the personality assessment data for the individual sales person is obtained, predict at least one of behavior characteristics and competency characteristics for the individual sales person based on the personality assessment data for the individual sales person and at least a first portion of the predictive characteristics;
where the behavior assessment data for the individual sales person is obtained, predict competency characteristics for the individual sales person based on the behavior assessment data for the individual sales person and at least a second portion of the predictive characteristics; and
where the competency assessment data for the individual sales person is obtained, predict behavior characteristics for the individual sales person based on the competency assessment data for the individual sales person and at least a third portion of the predictive characteristics.

21. A sales force assessment apparatus, comprising:
a data collection and storage component, in communication with a plurality of user terminals via at least one communication network, operable to receive, from at least one user terminal of the plurality of user terminals, personality assessment data, behavior assessment data and competency assessment data for a sales person to provide overall individual assessment data; and
a data analysis component, in communication with the data collection and storage component, operable to aggregate the overall individual assessment data with additional overall individual assessment data from a plurality of sales persons affiliated with an organization with which the sales person is also affiliated to provide aggregated assessment data, to compare at least one of the individual assessment data and the aggregated assessment data with high sales performer benchmark data to provide comparison results, and to identify improvement opportunities and one or more specific actions based on the comparison results.

22. The apparatus of claim 21, the data collection and storage component further comprising a user interface generation component operable to provide a user interface to the at least one user terminal.

23. The apparatus of claim 21 further comprising a reporting component operable to generate a report comprising information concerning at least one of the overall individual assessment data, the aggregated assessment data and the comparison results.

24. The apparatus of claim 23, the reporting component being further operable to provide the report to one or more of the plurality of user terminals.
